(19) United States
(12) Patent Application Publication
(10) Pub. No.: US 2009/0192835 A1
(43) Pub. Date: Jul. 30, 2009

(54) System for Managing a License Associated with a Molding Structure

(75) Inventors: Martin H. BAUMANN, Burlington, VT (US); Geoffrey Gow, Palgrave (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: Husky Injection Molding Systems Ltd.

(21) Appl. No.: 12/018,904

(22) Filed: Jan. 24, 2008

(51) Int. Cl. G06Q 10/00; G06F 19/00; G06Q 30/00

(52) U.S. Cl. 705/7; 705/1; 705/34

(57) ABSTRACT

Disclosed, amongst other things, is a method executable in an asset management entity associated with a proprietor of the molding structure, a method executable in a supervisory entity associated with the molding structure, the asset management entity, and the supervisory entity, amongst other things. The asset management entity includes a computing apparatus. A license management module is associated with the computing apparatus. The supervisory entity includes a computing device. The computing apparatus is configured to execute, in use, a receiving operation, over a communication network, to receive an indication of a parameter of a license associated with the molding structure from the supervisory entity. The license management module is configured to execute, in use, a generating operation, to generate a command signal in accordance with the indication. The command signal is for causing the supervisory entity to execute an operation in accordance with the license.

### TECHNICAL FIELD

The present invention generally relates to, but is not limited to, a computer-based structure and steps for managing a license associated with a molding structure, and more specifically the present invention relates to, but is not limited to, a method executable in an asset management entity associated with a proprietor of the molding structure, a method executable in a supervisory entity associated with the molding structure, the asset management entity, and the supervisory entity, amongst other things.

### BACKGROUND

An issue for a molding material converter is the very high upfront investment costs for molding structure such as, for example, the molding structure associated with an injection molding system (e.g. the injection molding machine, mold, or hot runner).

An issue for a proprietor of the molding structure, be he the molding material converter or another entity (e.g. the manufacturer of the molding structure), is the lack of a business model, and related system with which to implement the business model, to salvage used molding structure (e.g. the mold or hot runner). Molding structures and related components that are made from steel and other expensive alloy materials are built to last typically much longer than they are required to run.

Another issue facing the proprietor of the molding structure is the lack of an apparatus and method for managing a license associated with the molding structure. For example, the proprietor of the molding structure may wish to place the molding structure with another entity for the operation thereof under terms of a license and yet there is no adequate means to police the license.

### SUMMARY

According to a first aspect of the present invention, there is provided a method executable in an asset management entity that includes a license management module. The asset management entity being associated with a proprietor of a molding structure and the molding structure for use by a molding material converter. The method includes a receiving operation, including receiving, over a communication network, an indication of a parameter of a license associated with the molding structure from a supervisory entity associated with the molding structure. The method also includes a generating operation, including generating a command signal in accordance with the indication, the command signal for causing the supervisory entity to execute an operation in accordance with the license. The method further includes a transmitting operation, including transmitting, over the communication network, the command signal to the supervisory entity.

According to a second aspect of the present invention, there is provided a method executable in a supervisory entity associated with a molding structure for use by a molding material converter. The method includes a sending operation, including sending, over a communication network, an indication of a parameter of a license associated with the molding structure to an asset management entity that includes a license management module. The asset management entity being associated with a proprietor of the molding structure. The method also includes an accepting operation, including accepting, over the communication network, a command signal from the asset management entity. The command signal being generatable in the asset management entity in accordance with the indication. The method further includes a producing operation, including producing an operation signal in accordance with the command signal for causing the molding structure to execute an operation in accordance with the license.

According to a third aspect of the present invention, there is provided an asset management entity being associated with a proprietor of a molding structure. The molding structure for use by a molding material converter. The asset management entity includes a computing apparatus. The asset management entity also includes a computing apparatus interface associated with the computing apparatus. The computing apparatus interface is configured to operatively couple, in use, the computing apparatus to a communication network for communications with a supervisory entity associated with the molding structure. The computing apparatus is configured to execute, in use, a receiving operation, over the communication network, to receive an indication of a parameter of a license associated with the molding structure from the supervisory entity. The asset management entity also includes a license management module associated with the computing apparatus. The license management module is configured to execute, in use, a generating operation, to generate a command signal in accordance with the indication. The command signal for causing the supervisory entity to execute an operation in accordance with the license. The computing apparatus is configured to execute, in use, a transmitting operation, to transmit, over the communication network, the command signal to the supervisory entity.

According to a fourth aspect of the present invention, there is provided a supervisory entity being associated with a molding structure. In addition, the computing device is configured to execute, in use, a accepting operation to accept, over the communication network, a command signal from the asset management entity. The command signal being generatable in the asset management entity in accordance with the indication. The computing device is configured to execute, in use, a producing operation to produce an operation signal in accordance with the command signal for causing the molding structure to execute an operation in accordance with the license.

A technical effect, amongst others, of the aspects of the present invention may include structure and/or steps for a proprietor of a molding structure to manage a license associated with the molding structure, the molding structure for operation by a molding material converter.

### DETAILED DESCRIPTION OF THE DRAWINGS

A better understanding of the exemplary embodiments of the present invention including alternatives and/or variations thereof may be obtained with reference to the detailed description of the exemplary embodiments along with the following drawings, in which:

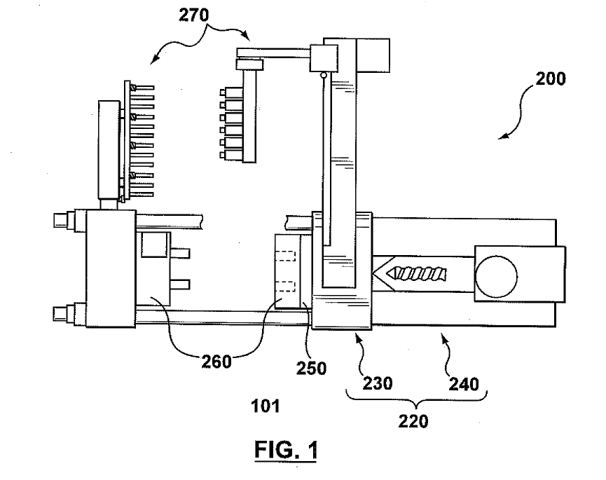

FIG. 1 is a plan view of an injection molding system made up of various molding structures that may be associated with the present invention;

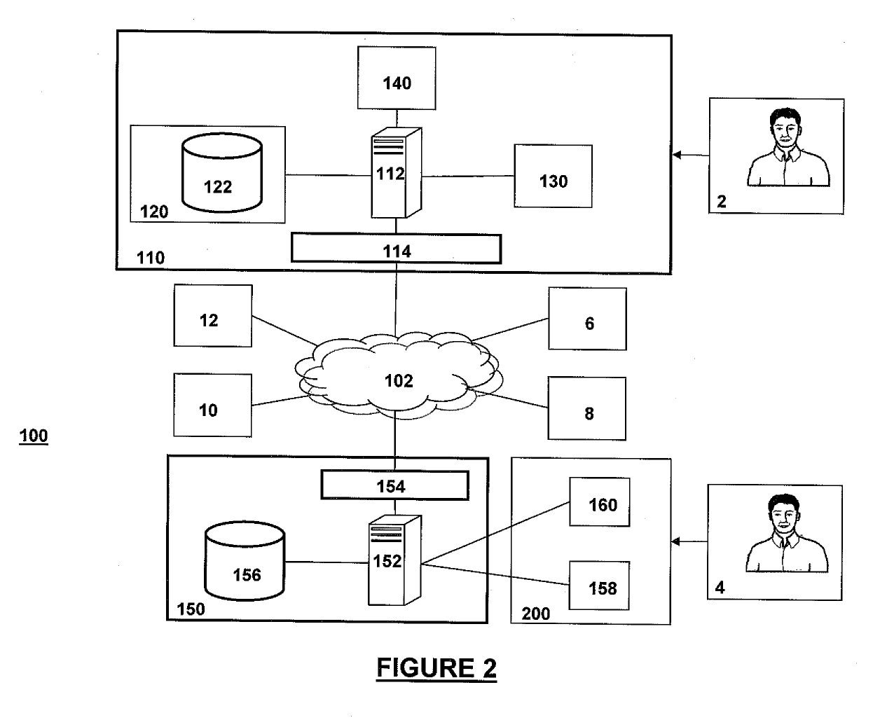

FIG. 2 is a conceptual view of a system in accordance with a non-limiting embodiment of the present invention; and

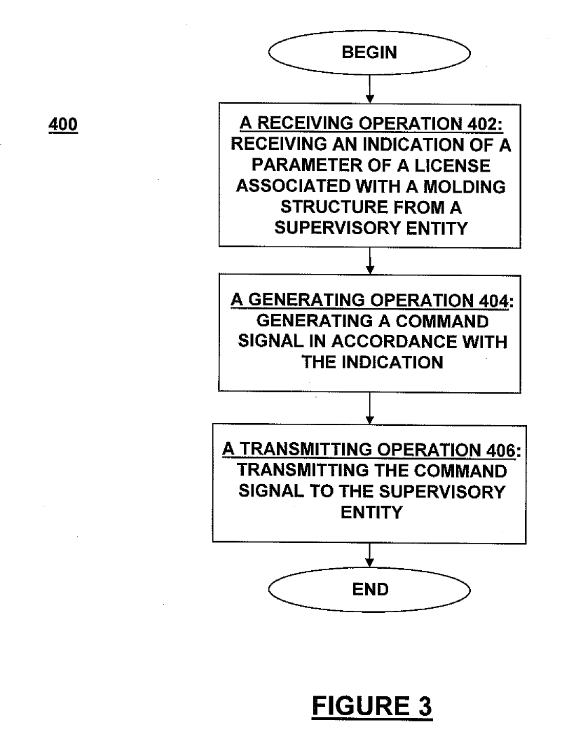

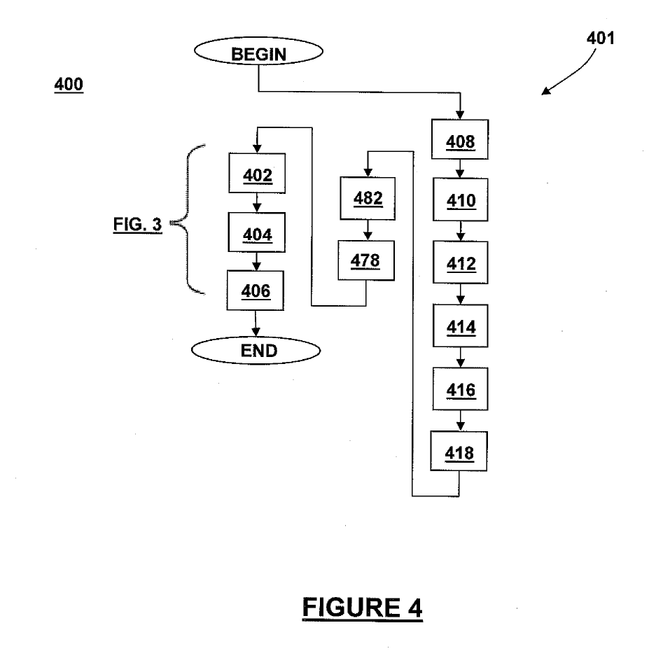

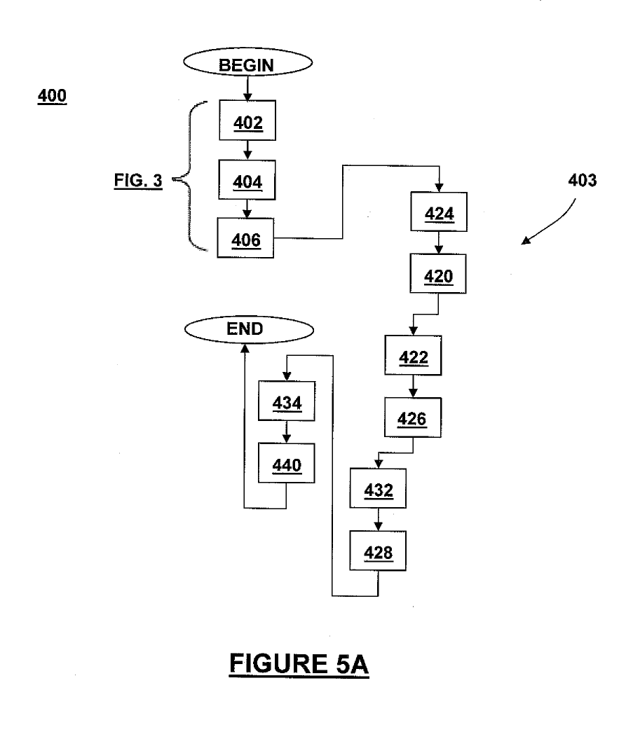

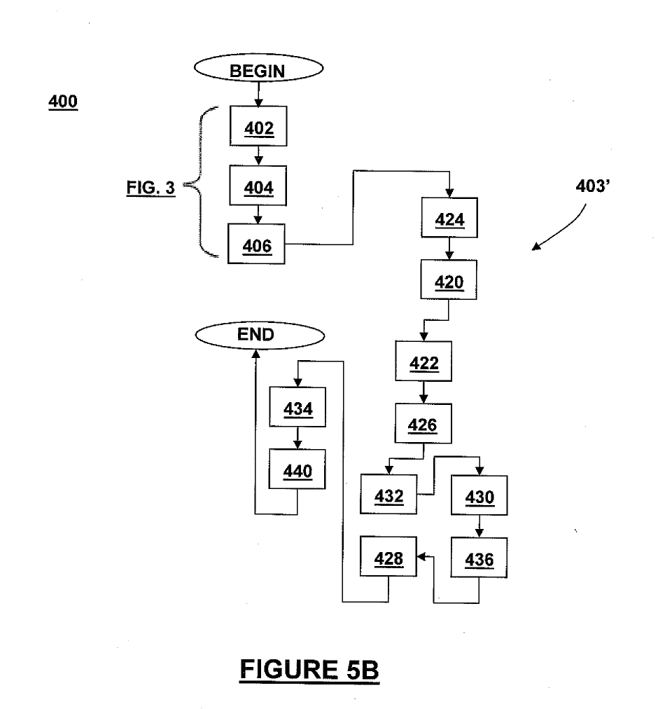

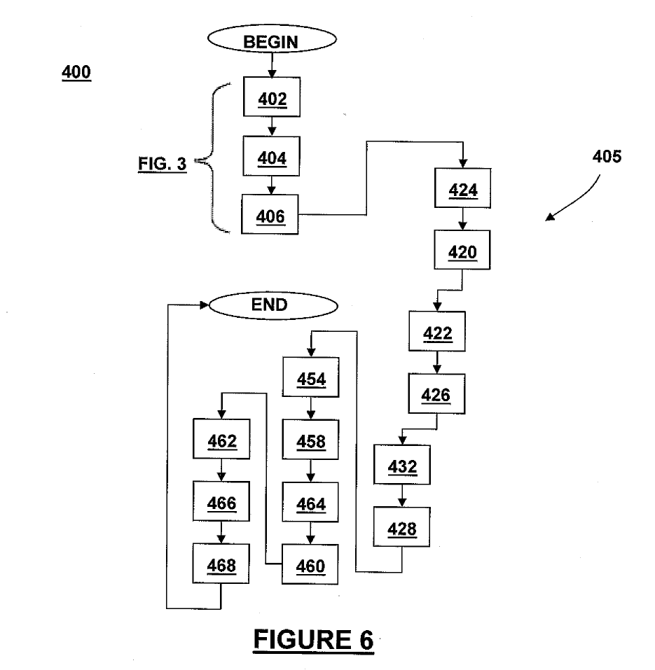

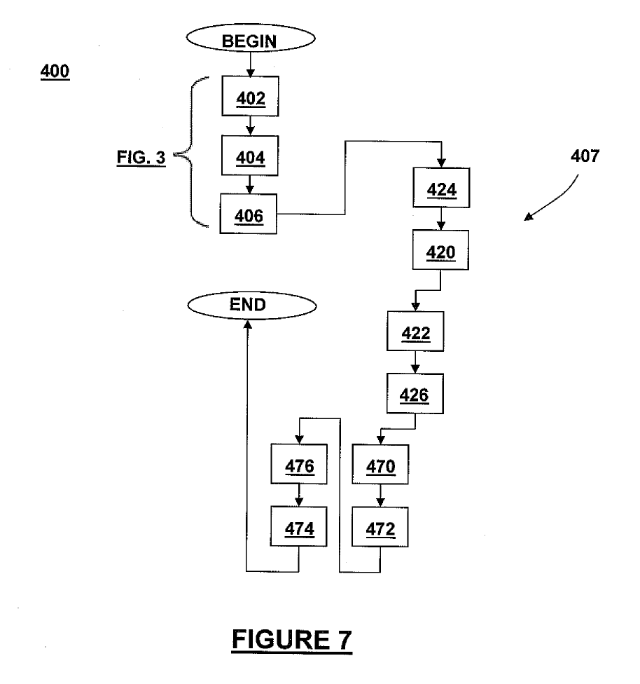

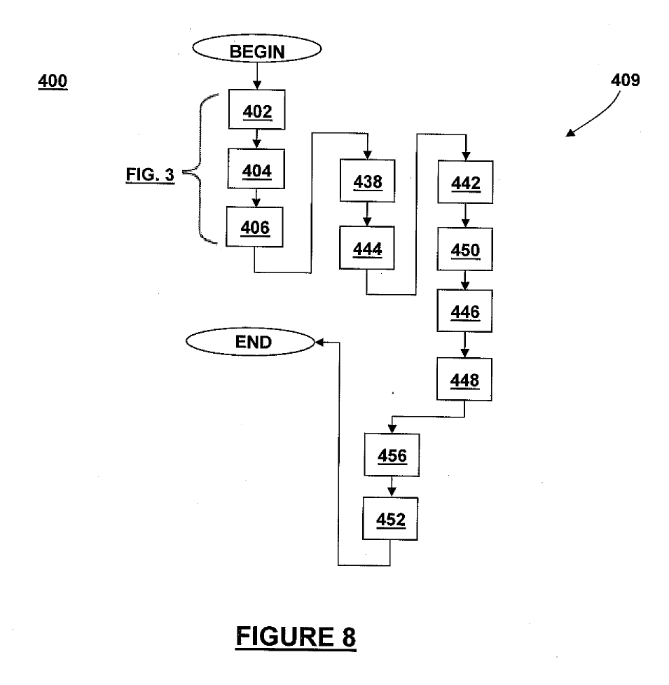

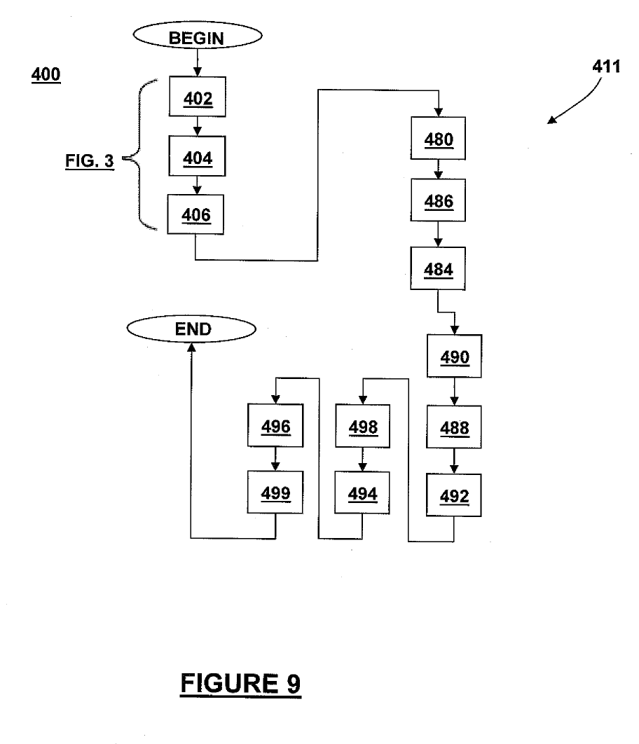

FIG. 3 is a flow-chart representative of a method executable in an asset management entity;

FIG. 4 is a flow-chart representative of the method of FIG. 3 further including a deployment sub-routine;

FIG. 5A is a flow-chart representative of the method of FIG. 3 further including a period sub-routine;

FIG. 5B is a flow-chart representative of the method of FIG. 3 further including a variant to the period sub-routine;

FIG. 6 is a flow-chart representative of the method of FIG. 3 further including a suspend sub-routine;

FIG. 7 is a flow-chart representative of the method of FIG. 3 further including a retire sub-routine;

FIG. 8 is a flow-chart representative of the method of FIG. 3 further including a decommission sub-routine;

FIG. 9 is a flow-chart representative of the method of FIG. 3 further including a maintenance sub-routine;

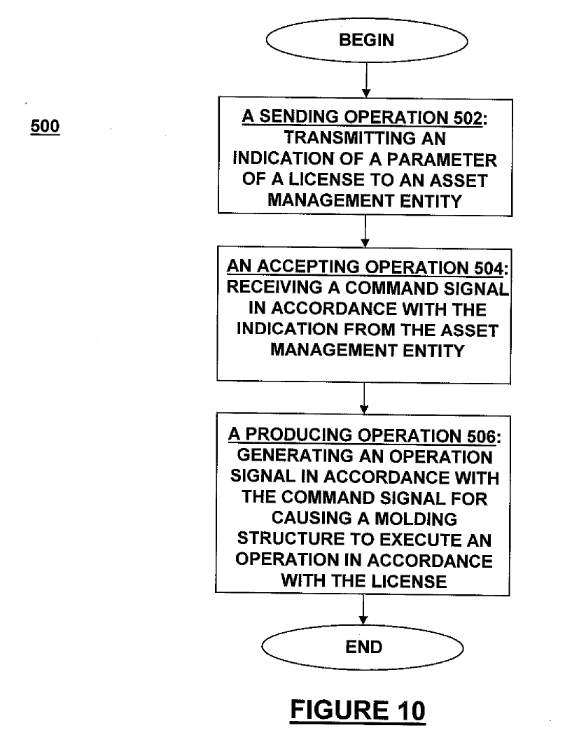

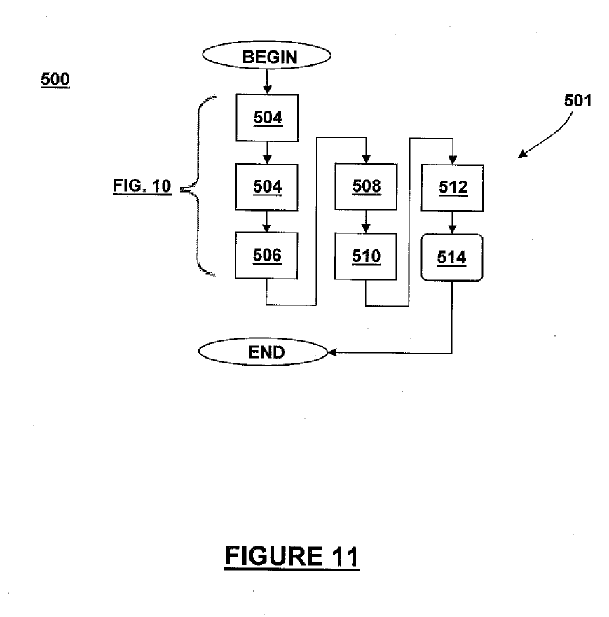

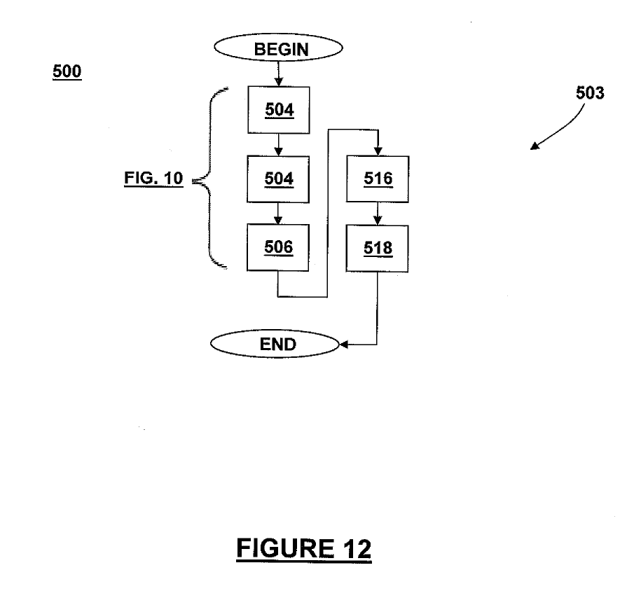

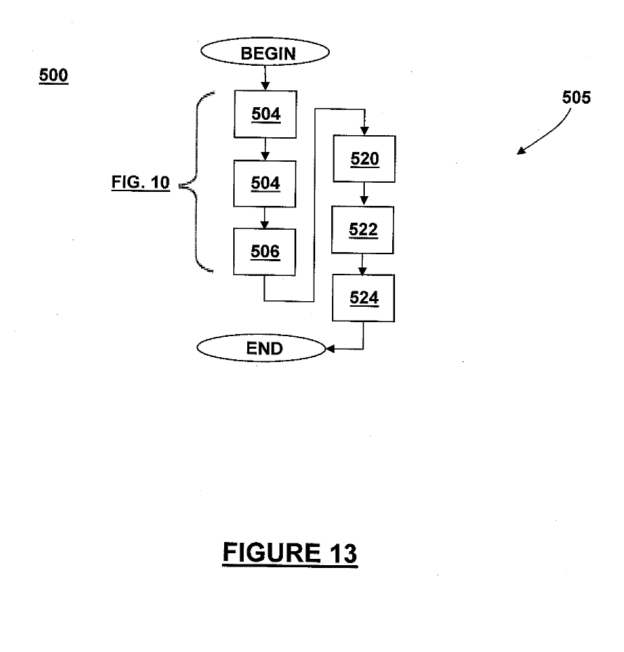

FIG. 10 is a flow-chart representative of a method executable in the supervisory entity;

FIG. 11 is a flow-chart representative of the method of FIG. 10 further including a period-report sub-routine;

FIG. 12 is a flow-chart representative of the method of FIG. 10 further including a decommission sub-routine;

FIG. 13 is a flow-chart representative of the method of FIG. 10 further including a maintenance sub-routine.

The drawings are not necessarily to scale and are may be illustrated by phantom lines, diagrammatic representations and fragmentary views. In certain instances, details that are not necessary for an understanding of the exemplary embodiments or that render other details difficult to perceive may have been omitted.

### DETAILED DESCRIPTION OF THE EXEMPLARY EMBODIMENTS

### Introduction:

In the non-limiting embodiments of the present invention that follow, a computer implemented method and apparatus are provided for a proprietor of a molding structure to manage a license associated with the molding structure that has been placed with a molding material converter.

The proprietor may be, but not limited to, a manufacturer of the molding structure or any other entity that has assumed ownership of the molding structure.

The molding material converter is any entity that has possession of the molding structure for sake of using is to convert a molding material (e.g. a polymeric material, such as Polyethylene Terephthalate, or a metal alloy, such as a magnesium alloy) into a molded article.

As shown with reference to FIG. 1, the molding structure may be, but not limited to, a molding structure 200 associated with an injection molding system. More particularly, the molding structure 200 may include any of one, or combination or permutation of, an injection molding machine 220 having a clamp 230 and an injection unit 240, a hot runner 250, a mold 260, a post-mold device 270 (e.g. molded article handling structure), an auxiliary molding device (e.g. resin dryer, water chiller, etc.—not shown), a controller (not shown), and a computer-readable product including controller executable instructions for performing a molding operation (not shown). The construction and operation of the foregoing molding structure 200 is well known to those skilled in the art.

### Pay-Per-Shot Business Model

As will be explained in detail to follow, a method and apparatus in accordance with a non-limiting embodiment of the present invention may be employed to implement a ‘pay-per-shot’ business model. The pay-per-shot business model solves at least some of the issues discussed in the background.

The pay-per-shot business model allows a proprietor of a molding structure to place the molding structure with a molding material converter, virtually free of charge, or at a lower cost as compared to the price they would pay for a new system, in exchange for a commitment from the molding material converter to pay the proprietor of the molding structure an incremental cost for each shot of molding material taken therewith. Accordingly, the fee per shot would be a parameter of a license, likely amongst many, associated with the molding structure. Once the molding structure is no longer required by the molding material converter it is simply recovered by the proprietor.

Optionally, the license may include other parameters agreed to by the proprietor and the molding material converter. An example of an additional license parameter may include a service parameter for services to be rendered by the proprietor, or agents acting on behalf thereof, in relation to the molding structure. The service may include, for example, shipment, installation, removal, or maintenance thereof. In the scenario where the license includes a maintenance parameter, a service entity associated with the proprietor may assume responsibility for maintaining the molding structure and any required spare part. Alternatively, the spare parts may be charged separately to the molding material converter. In such a scenario, the molding structure may be equipped with a means for identifying a maintenance requirement or to act as a trouble shooting tool to keep maintenance and travel costs for the proprietor to a minimum.

In addition, an automated invoicing and payment architecture may be provided. Invoicing may be established, for example, on the basis of the molding cycle count cycles, as discussed previously, and then invoiced automatically according to a schedule (e.g. once a week or month).

Once recovered from the molding material converter, the proprietor may optionally inspect the molding structure for serviceability, refurbish all or part of it, as required, and then re-use the molding structure, in whole, or in part. For example, wherein the molding structure is a hot runner, components thereof, including the base, manifolds and nozzles, may be salvaged for building another hot runner.

Accordingly, an underlying premise of the non-limiting embodiment of the pay-per-shot business model is that the proprietor of the molding structure takes care of the molding structure whereas the molding material converter takes care of operating it to make molded articles.

The foregoing is in sharp contrast to a sales model which requires a commitment from the molding material converter to pay for the molding structure in its entirety, or a leasing model, which requires the molding material provider to pay a predefined number of payments regardless of whether the molding structure is operated or not. It should be noted however that the inventor has recognized that the present invention could alternatively be implemented in managing a license associated with a molding structure that has been purchased or leased by the molding material converter.

Advantageously, the pay-per-shot business model is implemented in association with a molding structure that has been configured in accordance with a ‘flexible design’. A molding structure configured in accordance with a flexible design incorporates features that renders it readily reconfigurable to accommodate a range of configurations. Examples of flexible design are well known to those skilled in the art of molding. A non-limiting example of such a flexible design may be found in a hot runner having a manifold design that accommodates a range of nozzle drop arrangements i.e. spacing between groups of nozzles of an array thereof. An example of a hot runner having a flexible design is described with reference to U.S. Pat. No. 5,536,164 Inventor: BRUN, Charles et al.; Published: Jul. 16, 1996. The '164 patent teaches, amongst other things, the notion of a flexible manifold conduit for connecting a flow divider with manifold outlets. Such a flexible manifold conduit of could be easily re-shaped to accommodate a revised drop location. The flexible manifold runners are ideal because they can readily be re-positioned to new drop locations, if enough slack is provided. Additionally, a low strength manifold, such as one made with low grade steel or through free form fabrication, can be used in the production of such molded pieces requiring high pressure injection.

Further advantages may also be derived from configuring the hot runner to include an injection apparatus capable of injecting melt into a mold cavity at high pressure while utilizing a low pressure injection unit and manifold. Such an injection apparatus is the subject of co-pending and commonly assigned U.S. patent application Ser. No. 11/931,106. The injection apparatus, or modified hot runner nozzle assembly includes a cavity contained within and defined by a housing. In operation, the cavity receives melt at low pressure via the low pressure manifold. When the cavity is appropriately filled with melt, a selectively closable valve intermediate to the low pressure manifold and the cavity closes, thereby isolating melt in the cavity. A plunger within the cavity is then driven forward increasing the pressure of the melt within the cavity and injecting melt in the mold cavity at high pressure. The valve prevents any substantial backflow of melt, and any substantial increase in the pressure of melt within, the low pressure manifold. A technical effect of the foregoing is the ability to reuse the low pressure manifold for a greater variety of applications i.e. hot runners having a wide range of operating pressures.

Notwithstanding the applicability of the method and apparatus of the present invention in realizing the foregoing pay-per-shot business model, the present invention is not so limited, and hence may be useful in the enforcement of any license associated with all varieties of molding structure.

### System

With reference to FIG. 2, a system 100 is shown in accordance with a non-limiting embodiment of the present invention. The system 100 includes an asset management entity 110 that is associated with a proprietor 2 of a molding structure 200 (FIG. 1). The molding structure 200 for use by a molding material converter 4. The asset management entity 110 includes a computing apparatus 112. A computing apparatus interface 114 is associated with the computing apparatus 112, the computing apparatus interface 114 is configured to operatively couple, in use, the computing apparatus 112 to a communication network 102 for communications with a supervisory entity 150 associated with the molding structure 200. The computing apparatus 112 is configured to execute, in use, a receiving operation 402 (reference FIGS. 4-9 for a depiction of this, and subsequent operations of a method 400 of operating the asset management entity 110), over the communication network 102, to receive an indication of a parameter of a license associated with the molding structure 200 from the supervisory entity 150. A license management module 120 is associated with the computing apparatus 112. The license management module 120 is configured to execute, in use, a generating operation 404, to generate a command signal in accordance with the indication. The command signal is for causing the supervisory entity 150 to execute an operation in accordance with the license. The computing apparatus 112 is further configured to execute, in use, a transmitting operation 406, to transmit, over the communication network 102, the command signal to the supervisory entity 150.

The command signal in accordance with the indication may be for causing the supervisory entity 150 to execute the operation in accordance with the license that is a locking operation or an unlocking operation of the molding structure 200.

The indication of the parameter of the license may include an account indication of an account parameter of the license. When the account indication being indicative of the license being in good standing, the command signal in accordance with the indication is an unlock command signal in accordance with the account indication. The unlock command signal for causing the supervisory entity 150 to execute the operation that is an unlocking operation of the molding structure 200 in accordance with the license, thereby causing the molding structure 200 to be operable. The license may be considered to be in good standing, for example, in association with the molding material converter 4 having paid the proprietor 2 for a total number of cycles that the molding structure 200 was operated by the molding material converter 4 over a period of time.

Likewise, the indication of the parameter of the license may include an account indication of the account parameter of the license, the account indication being indicative of the license being in arrears. In such a scenario, the command signal in accordance with the indication may include a lock command signal in accordance with the account indication. The lock command signal for causing the supervisory entity 150 to execute the operation that is a locking operation of the molding structure 200 in accordance with the license, thereby causing the molding structure 200 to be inoperable. The license may be considered to be in arrears, for example, in association with the molding material converter 4 having not paid the proprietor 2 for a total number of cycles that the molding structure 200 was operated by the molding material converter 4 over a period of time.

The asset management entity 110 may further include a configurating module 130. The computing apparatus 112 is configured to execute, in use, a demand receiving operation 408 to receive, over the communication network 102, a demand indication from the molding material converter 4. The demand indication is indicative of a demand for the molding structure 200 in accordance with a molding structure specification. The configurating module 130 is configured to execute, in use, a build generating operation 410 to generate a build command signal in response to the demand indication. The build command signal for causing a manufacturing entity 8 associated with the proprietor 2 to configure the molding structure 200 in accordance with the molding structure specification. The computing apparatus 112 is configured to execute, in use, a build transmitting operation 412 to transmit over the communication network 102, the build command signal to the manufacturing entity 8. The computing apparatus 112 is configured to execute, in use, a completion receiving operation 414 to receive, over the communication network 102, a completion indication from the manufacturing entity 8 that the molding structure 200 is ready for deploying to the molding material converter 4. The computing apparatus 112 is configured to execute, in use, a deploy generating operation 416 to generate a deploy command signal in response to the completion indication for causing a service entity 10 associated with the proprietor 2 to deploy the molding structure 200 to the molding material converter 4. The computing apparatus 112 is configured to execute, in use, a deploy transmitting operation 418 to transmit, in use, over the communication network 102, the deploy command signal to the service entity 10 for causing the service entity 10 associated with the proprietor 2 to deploy the molding structure 200 to the molding material converter 4.

The indication of the parameter of the license may include an acceptance indication of an acceptance parameter of the license. The acceptance indication is indicative of the molding structure 200, and the license associated therewith, having been accepted by the molding material converter 4. In such a scenario, the command signal in accordance with the indication includes an unlock command signal in accordance with the acceptance indication. The unlock command signal for causing the supervisory entity 150 to execute the operation that is an unlocking operation of the molding structure 200 in accordance with the license, thereby causing the molding structure 200 to be operable.

The asset management entity 110 may further include a master register 122 (e.g. a table in a database) associated with the license management module 120. The master register is configured to store a count and a period of time receivable from the client register 156 (i.e. a table in a database) associated with the supervisory entity 150. The license management module 120 is configured to execute, in use, an initialize generating operation 424 in accordance with the acceptance indication to generate a register-initialize command signal for causing an initializing (i.e. zeroing) of the client register 156 of the supervisory entity 150. The client register 156 for storing the count of a number of cycles that the molding structure 200 has been operated by the molding material converter 4 over the period of time. The register-initialize command signal also for causing an initializing of the master register 122. The computing apparatus 112 is configured to execute, in use, an initialize transmitting operation 420 to transmit, over the communication network 102, the register-initialize command signal to the supervisory entity 150.

The computing apparatus 112 may be configured to execute, in use, a period-report receiving operation 422 to receive, over the communication network 102, a period-report indication of a report parameter of the license from the supervisory entity 150. The period-report indication may be indicative, for example, of the count from the client register 156 over the period of time. The license management module 120 is configured to execute, in use, a store generating operation 426 to generate a store command signal in response to the period-report indication. The store command signal for causing storing of the count and the period of time in the master register 122.

The asset management entity 110 may further include a proprietor billing module 140. The proprietor billing module 140 is configured to execute, in use, a period-bill generating operation 432 to generate a period-bill command signal in response to the store command signal. The period-bill command signal for causing a calculation of a period amount of a currency that the molding material converter 4 will need to transmit to the proprietor 2. The calculating may be based, for example, on at least one of the count and the period of time stored in the master register 122 and a compensation parameter of the license. The computing apparatus 112 is configured to execute, in use, a period-bill transmitting operation 428 to transmit, over the communication network 102, a period-bill request signal to a molding material converter financial entity 12. The period-bill request signal is indicative of the period amount of the currency due and terms of payment. The compensation parameter of the license may include, for example, a specified amount of the currency per molding cycle and/or per unit of time that the molding structure 200 is with the molding material converter 4.

The computing apparatus 112 may be further configured to execute, in use, a cycle-credit receiving operation 430 to receive, over the communication network 102, a cycle-credit indication of the report parameter of the license from the supervisory entity 150. The cycle-credit indication is indicative of a cycle-credit count for which the molding material converter 4 is not responsible. The proprietor billing module 140 is configured to execute, in use, adjusted-bill generating operation 436 to generate the period-bill command signal wherein the calculation further based on subtracting the cycle-credit count from the count. In this way, the molding material converter would not have to pay for cycles of the molding structure under certain conditions. Such conditions may include, for example, faulty operation of the molding structure when the fault does not lie with the molding material converter (e.g. faulty molding structure).

The computing apparatus 112 may be further configured to execute, in use, a period-payment receiving operation 434 to receive, over the communication network 102, a period-payment indication of the compensation parameter of the license from a proprietor financial entity 6. The period-payment indication is indicative that the period amount of the currency from the molding material converter financial entity 12 has been received in accordance with the terms of payment. The license management module 120 is configured to execute, in use, an renew generating operation 440 to generate a renew command signal in accordance with the period-payment indication for causing an indexing of the master register 122. Indexing of the master register 122 allows for an indexed storing of the count and the period of time subsequently receivable from the supervisory entity 150 (e.g. entering further values in the table).

Likewise, the computing apparatus 112 may be further configured to execute, in use, a non-payment receiving indication 454 to receive, over the communication network 102, a non-payment indication of the compensation parameter of the license from a proprietor financial entity 6. The non-payment indication is indicative that the period amount of the currency from the molding material converter financial entity 12 has not been received in accordance with the terms of payment. Under such a circumstance, the license management module 120 is configured to execute, in use, a lock generating operation 458 to generate a lock command signal in accordance with the non-payment indication. The lock command signal for causing the supervisory entity 150 to execute the operation that is a locking operation of the molding structure 200 in accordance with a penalty parameter of the license, thereby causing the molding structure 200 to be inoperable and thereby suspending the license. The proprietor billing module 140 is configured to execute, in use, penalty-bill generating operation 464 to generate a penalty-bill command signal in response to the non-payment indication. The penalty-bill command signal for causing the calculation of a penalty amount of the currency that the molding material converter 4 will need to transmit to the proprietor 2 in accordance with the terms of the license. The computing apparatus 112 is configured to execute, in use, a penalty-bill transmitting operation 460 to transmit, over the communication network 102, a penalty-bill request signal to the molding material converter financial entity 12, the penalty-bill request signal is indicative of the penalty amount of the currency due and the terms of payment. Accordingly, the proprietor billing module 140 is configured to execute, in use, a penalty-payment receiving operation 462 to receive, over the communication network 102, a penalty-payment indication from the proprietor financial entity 6. The penalty-payment indication is indicative that the penalty amount of the currency from the molding material converter financial entity 12 has been received in accordance with the terms of payment. The license management module 120 is configured to execute, in use, a renew generating operation 466 to generate a renew command signal in accordance with the penalty-payment indication for causing an indexing of the master register 122 for storing the count and the period of time subsequently receivable from the supervisory entity 150. The license management module 120 is configured to execute, in use, a unlock generating operation 468 generates the unlock command signal in accordance with the penalty-payment indication. The unlock command signal for causing the supervisory entity 150 to execute the operation that is the unlocking operation of the molding structure 200 in accordance with the license, thereby restoring the license and causing the molding structure 200 to be once again operable.

The computing apparatus 112 may be further configured to execute, in use, a decommission receiving operation 438 to receive, over the communication network 102, a decommission indication from the molding material converter 4. The decommission indication is indicative of the molding structure 200 being decommissioned by the molding material converter 4. The computing apparatus 112 is configured to execute, in use, a recovery generating operation 444 to generate a recovery command signal in response to the decommission indication for causing the service entity 10 associated with the proprietor 2 to recover the molding structure 200 from the molding material converter 4. Accordingly, the computing apparatus 112 may be further configured to execute, in use, a recovery receiving operation 442 to receive, over the communication network 102, a recovery indication from the service entity 10. The recovery indication is indicative of a recovery of the molding structure 200 by the proprietor 2.

The computing apparatus 112 may be further configured to execute, in use, an inspect generating operation 450 to generate an inspect command signal in response to the recovery indication. The inspect command signal for causing the manufacturing entity 8 to inspect the molding structure 200 for reusability. The computing apparatus 112 is configured to execute, in use, an inspect transmitting operation 446 to transmit, over the communication network 102, the inspect command signal to the manufacturing entity 8. The computing apparatus 112 is configured to execute, in use, a inspection receiving operation 448 to receive, over the communication network 102, an inspection indication from the manufacturing entity 8. The inspection indication is indicative of a refurbishment requirement of the molding structure 200.

The computing apparatus 112 may be further configured to execute, in use, a refurbishment generating operation 456 to generate a refurbishment command signal in response to the inspection indication. The refurbishment command signal for causing the manufacturing entity 8 to refurbish the molding structure 200, at least in part, in accordance with the refurbishment requirement. The computing apparatus 112 is configured to execute, in use, a refurbishment receiving operation 452 to receive, over the communication network 102, a refurbishment indication from the manufacturing entity 8. The refurbishment indication is indicative of the molding structure 200, at least in part, having been refurbished in accordance with the refurbishment requirement. The refurbished molding structure, in whole, or in part, in then ready for deployment as another molding structure.

Of course, the molding structure may be operated by the molding material converter to the point that the molding structure is considered to be fully depreciated. Under such a scenario, the license management module 120 may be further configured to execute, in use, a summary generating operation 470 to generate a summary command signal in response to the store command signal. The summary command signal for causing a calculating of a total cycle count based on a sum of the count indexed in the master register 122 since the master register 122 was initialized. Likewise, the summary command signal for causing a total service time based on a further sum of the period of time entries indexed in the master register 122 since the master register 122 was initialized. The license management module 120 is configured to execute, in use, a lock generating operation 472 to generate a lock command signal in accordance with at least one of the total cycle count reaching a maximum service count parameter associated with the license and/or the total service time reaching a maximum service time parameter associated with the license. The lock command signal for causing the supervisory entity 150 to execute the operation that is a locking operation of the molding structure 200 in accordance with the license, thereby causing the molding structure 200 to be inoperable thereby canceling the license. At this point the molding material converter could choose to either return the depreciated molding structure or to purchase it. Accordingly, the proprietor billing module 140 is configured to execute, in use, a sale generating operation 476 to generate a sale command signal, the sale command signal for causing a calculating of a residual amount of a currency that the molding material converter 4 will need to transmit to the proprietor 2 in order to purchase the molding structure 200 in accordance with a residual-value parameter of the license. The computing apparatus 112 is configured execute, in use, a residual-bill transmitting operation 474 to transmit, over the communication network 102, a residual-bill request signal to a molding material converter financial entity 12, the residual-bill request signal is indicative of the residual amount of the currency.

Optionally, the proprietor may agree to conduct maintenance, routine or otherwise, on the molding structure while it is in use by the molding material converter. Under such a scenario, the computing apparatus 112 may be further configured to execute, in use, a maintenance receiving operation 480 to receive, over the communication network 102, a maintenance indication from the supervisory entity 150. The maintenance indication is indicative of a maintenance requirement of the molding structure 200. The computing apparatus 112 is configured to execute, in use, maintenance generating operation 486 to generate a maintenance command signal in response to the maintenance indication. The maintenance command signal for causing a service entity 10 associated with the proprietor 2 to service the molding structure 200 in accordance with the maintenance requirement. The computing apparatus 112 is configured to execute, in use, a maintenance transmitting operation 484 to transmit, over the communication network 102, the maintenance command signal to the service entity 10.

As a component of the maintenance agreement, or simply as a means to protect the molding structure in the face of the maintenance indication, the license management module 120 may be configured to execute, in use, a lock generating operation 490 to generate a lock command signal in accordance with the maintenance indication. The lock command signal for causing the supervisory entity 150 to execute the operation that is the locking operation of the molding structure 200 in accordance with the license, thereby causing the molding structure 200 to be inoperable and thereby preventing damage to the molding structure 200. The computing apparatus 112 is configured to execute, in use, a serviced receiving operation 488 to receive, over the communication network 102, a serviced indication from the service entity 10, the serviced indication is indicative of the maintenance requirement of the molding structure 200 having been addressed. The license management module 120 is configured to execute, in use, a unlock generating operation 492 to generate an unlock command signal in accordance with the serviced indication. The unlock command signal for causing the supervisory entity 150 to execute the operation that is the unlocking operation of the molding structure 200 in accordance with the license, thereby causing the molding structure 200 to be operable.

Any monetary cost incurred by the proprietor in providing the maintenance to the molding structure may be handled in any manner. For instance, the cost may be waived, included as a component of the compensation parameter (i.e. as a portion of the specified amount of the currency per molding cycle and/or per unit of time), or separately invoiced. With the latter, the proprietor billing module 140 is configured to execute, in use, a maintenance-bill generating operation 498 to generate a maintenance-bill command signal in response to the serviced indication. The maintenance-bill command signal for causing a calculating of a maintenance amount of a currency that the molding material converter 4 will need to transmit to the proprietor 2 for addressing the maintenance requirement of the molding structure 200 in accordance with a maintenance parameter of the license. The computing apparatus 112 is configured to execute, in use, a maintenance-bill transmitting operation 494 to transmit, over the communication network 102, a maintenance-bill request signal to a molding material converter financial entity 12. The maintenance-bill request signal is indicative of the maintenance amount of the currency due and terms of payment.

The computing apparatus 112 may be further configured to execute, in use, a maintenance-payment receiving operation 496 to receive, over the communication network 102, a maintenance-payment indication of the parameter of the license from a proprietor financial entity 6. The maintenance-payment indication is indicative that the maintenance amount of the currency from the molding material converter financial entity 12 has not been received in accordance with the terms of payment. The license management module 120 is configured to execute, in use, a further lock generating operation 499 to generate the lock command signal in accordance with the maintenance-payment indication. The lock command signal for causing the supervisory entity 150 to execute the operation that is the locking operation of the molding structure 200 in accordance with a penalty parameter of the license, thereby causing the molding structure 200 to be inoperable.

The supervisory entity 150 includes a computing device 152. A computing device interface 154 is associated with the computing device 152. The computing device interface 154 is configured to operatively couple, in use, the computing device 152 to a communication network 102 for communications with an asset management entity 110 associated with a proprietor 2 of the molding structure 200. The computing device 152 is configured to execute, in use, a sending operation 502 (reference FIGS. 10-13 for a depiction of this, and subsequent operations of a method 500 of operating the supervisory entity 150) to send, over the communication network 102, the indication of the parameter of a license associated with the molding structure 200 to the asset management entity 110. The computing device 152 is configured to execute, in use, an accepting operation 504 to accept, over the communication network 102, the command signal from the asset management entity 110. The computing device 152 is configured to execute, in use, a producing operation 506 to produce an operation signal in accordance with the command signal for causing the molding structure 200 to execute the operation in accordance with the license.

The operation signal in accordance with the command signal may be for causing a locking structure 160 associated with the molding structure 200 to execute the operation in accordance with the license that is one of a locking operation or an unlocking operation of the molding structure 200.

That is, the operation signal in accordance with the command signal may include an unlocking operation signal in accordance with the unlock command signal, the unlocking operation signal for causing a locking structure 160 associated with the molding structure 200 to execute the operation that is an unlocking operation of the molding structure 200 in accordance with the license, thereby causing the molding structure 200 to be operable.

Likewise, the operation signal in accordance with the command signal may include a locking operation signal in accordance with the lock command signal, the locking operation signal for causing a locking structure 160 associated with the molding structure 200 to execute the operation that is a locking operation of the molding structure 200 in accordance with the license, thereby causing the molding structure 200 to be inoperable.

The computing device 152 may further include a user interface (not shown). The user interface is configured to accept the acceptance indication of the acceptance parameter of the license, recalling that the acceptance indication is indicative of the molding structure 200, and the license associated therewith, having been accepted by the molding material converter 4.

As introduced previously, the supervisory entity 150 may further include the client register 156 for storing the count of the number of cycles that the molding structure 200 has been operated by the molding material converter 4 over the period of time. The computing device 152 is configured to execute, in use, an initialize accepting operation 508 to accept, over the communication network 102, the register-initialize command signal from the asset management entity 110. The computing device 152 is further configured to execute, in use, an initialize producing operation 510 to produce a client register-initialize operation signal for causing an initializing of the client register 156 of the supervisory entity 150.

As introduced previously, the computing device 152 may be configured to execute, in use, a period-report producing operation 512 to produce the period-report indication of the report parameter of the license, the period-report indication is indicative of the count from the client register 156 over the period of time. The computing device 152 is configured to execute, in use, a period-report sending operation 514 to send, over the communication network 102, the period-report indication to the asset management entity 110.

Likewise, the computing device 152 is configured to execute, in use, the period-report producing operation 512, in response to at least one of the count and the period of time reaching predefined values of a reporting count threshold and a reporting time threshold, respectively.

The computing device 152 may be further configured to execute, in use, a decommission producing operation 516 to produce a decommission indication. The decommission indication is indicative of the molding structure 200 being decommissioned by the molding material converter 4. The user interface may be configured to accept the decommission indication from the molding material converter 4. Alternatively, the computing device 152 may be configured to generate the decommission indication automatically on the basis of a trigger associated with a license parameter. Accordingly, the computing device 152 is configured to execute, in use, a decommission sending operation 518 to send, over the communication network 102, the decommission indication to the asset management entity 110.

The computing device 152 may be further configured to execute, in use, a monitor accepting operation 520 to accept, over the communication network 102, a monitor signal from a sensor 158 associated with the molding structure 200. The monitor signal is indicative of a maintenance requirement of the molding structure 200. The computing device 152 is configured to execute, in use, a maintenance producing operation 522 to produce a maintenance indication in response to the monitor signal. The maintenance indication is indicative of the maintenance requirement of the molding structure 200. The computing device 152 is configured to execute, in use, a maintenance sending operation 524 to send, over the communication network 102, the maintenance indication to the asset management entity 110.

In the foregoing non-limiting embodiment, the computing apparatus interface 114, the license management module 120, the configurating module 130, and the proprietor billing module 140 may be integral to the computing apparatus 112. Alternatively, for example, any one, or all, of the computing apparatus interface 114, the license management module 120, the configurating module 130, and the proprietor billing module 140 may be realized in a separate computing structure that is linked (e.g. cable, wireless, etc.) to the computing apparatus 112.

### Method of Operating the Asset Management Entity

Shown with reference to FIG. 3, the method 400 executable in the asset management entity 110 according the foregoing non-limiting embodiment includes the receiving operation 402, including receiving, over the communication network 102, the indication of the parameter of the license associated with the molding structure 200 from the supervisory entity 150 associated with the molding structure 200. The generating operation 404, including generating the command signal in accordance with the indication. The command signal for causing the supervisory entity 150 to execute the operation in accordance with the license. The transmitting operation 406, including transmitting, over the communication network 102, the command signal to the supervisory entity 150.

The operation in accordance with the license may include, for example, the locking operation or the unlocking operation of the molding structure 200.

The receiving of the indication of the parameter of the license may be the receiving the account indication of the account parameter of the license, the account indication being indicative of the license being in good standing. In such a scenario, the generating the command signal in accordance with the indication includes generating the unlock command signal in accordance with the account indication. The unlock command signal for causing the supervisory entity 150 to execute the operation that is the unlocking operation of the molding structure 200 in accordance with the license, thereby causing the molding structure 200 to be operable.

Likewise, the account indication may alternatively be indicative of the license being in arrears. In such a scenario, the generating the command signal in accordance with the indication includes generating the lock command signal in accordance with the account indication. The lock command signal for causing the supervisory entity 150 to execute the operation that is the locking operation of the molding structure 200 in accordance with the license, thereby causing the molding structure 200 to be inoperable.

With reference to FIG. 4, the method 400 may further include a deployment sub-routine 401. The deployment sub-routine 401 includes, prior to the receiving operation 402, the demand receiving operation 408, including receiving, over the communication network 102, the demand indication from the molding material converter 4. The demand indication is indicative of the demand for the molding structure 200 in accordance with the molding structure specification. The build generating operation 410, including generating the build command signal in response to the demand indication. The build command signal for causing the manufacturing entity 8 associated with the proprietor 2 to configure the molding structure 200 in accordance with the molding structure specification. The build transmitting operation 412, including transmitting, over the communication network 102, the build command signal to the manufacturing entity 8. The completion receiving operation 414, including receiving over the communication network 102, the completion indication from the manufacturing entity 8 that the molding structure 200 is ready for deploying to the molding material converter 4. The deploy generating operation 416, including generating the deploy command signal in response to the completion indication for causing the service entity 10 associated with the proprietor 2 to deploy the molding structure 200 to the molding material converter 4. The deploy transmitting operation 418, including transmitting, over the communication network 102, the deploy command signal to the service entity 10.

The deployment sub-routine 401 may further include the install-bill generating operation 482, including generating the install-bill command signal in response to the acceptance indication. The install-bill command signal for causing the calculating of the installation amount of the currency that the molding material converter 4 will need to transmit to the proprietor 2 for the installation of the molding structure 200 at the molding material converter 4 by the proprietor 2. The install-bill transmitting operation 478, including transmitting, over the communication network 102, the install-bill request signal to the molding material converter financial entity 12, the install-bill request signal is indicative of the installation amount of the currency due and terms of payment.

The receiving of the indication of the parameter of the license may be the receiving the acceptance indication of the acceptance parameter of the license. The acceptance indication is indicative of the molding structure 200, and the license associated therewith, having been accepted by the molding material converter 4. The generating the command signal in accordance with the indication includes generating the unlock command signal in accordance with the acceptance indication. The unlock command signal for causing the supervisory entity 150 to execute the operation that is the unlocking operation of the molding structure 200 in accordance with the license, thereby causing the molding structure 200 to be operable.

With reference to FIG. 5A, the method 400 may further include a period sub-routine 403. The period sub-routine 403 includes the initialize generating operation 424 in accordance with the acceptance indication, including generating the register-initialize command signal for causing the initializing of the client register 156 of the supervisory entity 150 and the client register 156 and the master register 122 of the license management module 120 for storing the count and the period of time receivable from the supervisory entity 150. The initialize transmitting operation 420, including transmitting, over the communication network 102, the register-initialize command signal to the supervisory entity 150.

The period sub-routine 403 may further include the period-report receiving operation 422, including receiving, over the communication network 102, the period-report indication of the report parameter of the license from the supervisory entity 150. The period-report indication is indicative of the count from the client register 156 over the period of time. The store generating operation 426, including generating the store command signal in response to the period-report indication, the store command signal for causing storing of the count and the period of time in the master register 122. The period-report indication may be generatable in the supervisory entity 150 in response to at least one of the count and the period of time reaching predefined values of the reporting count threshold and the reporting time threshold, respectively.

The period sub-routine 403 may further include the period-bill generating operation 432, including generating the period-bill command signal in response to the store command signal. The period-bill command signal for causing the calculating of the period amount of the currency that the molding material converter 4 will need to transmit to the proprietor 2 for use of the molding structure over the period. The calculating may be based, for example, on one, or both of, the count and the period of time stored in the master register 122 and the compensation parameter of the license. The period-bill transmitting operation 428, including transmitting, over the communication network 102, the period-bill request signal to the molding material converter financial entity 12, the period-bill request signal is indicative of the period amount of the currency due and terms of payment. The compensation parameter of the license may include, for example, the specified amount of the currency for one of, or both of, each cycle of the molding structure 200 taken by the molding material converter 4, the unit of time that the molding structure 200 is with the molding material converter 4.

The period sub-routine 403 may further include the period-payment receiving operation 434, including receiving, over the communication network 102, the period-payment indication of the compensation parameter of the license from the proprietor financial entity 6. The period-payment indication is indicative that the period amount of the currency from the molding material converter financial entity 12 has been received in accordance with the terms of payment. The renew generating operation 440, including generating the renew command signal in accordance with the period-payment indication for causing the indexing of the master register 122 for the indexed storing of the count and the period of time subsequently receivable from the supervisory entity 150.

With reference to FIG. 5B, a period sub-routine 403′ is shown. The period sub-routine 403′ is a variant to the period sub-routine 403. The period sub-routine 403′ further includes the operations of the period sub-routine 403, and further includes the cycle-credit receiving operation 430. The cycle-credit receiving operation 430, including receiving, over the communication network 102, the cycle-credit indication of the report parameter of the license from the supervisory entity 150. The cycle-credit indication is indicative of the cycle-credit count for which the molding material converter 4 is not responsible. The adjusted-bill generating operation 436, including generating the period-bill command signal includes the calculating further based on subtracting the cycle-credit count from the count.

With reference to FIG. 6, the method 400 may further include a suspend sub-routine 405. The suspend sub-routine 405 is the same as the period sub-routine 403 up to, and including, the period-bill transmitting operation 428. Thereafter, the suspend sub-routine 405 includes the non-payment receiving operation 454, including receiving, over the communication network 102, the non-payment indication of the compensation parameter of the license from the proprietor financial entity 6. The non-payment indication is indicative that the period amount of the currency from the molding material converter financial entity 12 has not been received in accordance with the terms of payment. The lock generating operation 458, including generating the lock command signal in accordance with the non-payment indication. The lock command signal for causing the supervisory entity 150 to execute the operation that is the locking operation of the molding structure 200 in accordance with the penalty parameter of the license, thereby causing the molding structure 200 to be inoperable and thereby suspending the license. The penalty-bill generating operation 464, including generating the penalty-bill command signal in response to the non-payment indication. The penalty-bill command signal for causing the calculation of the penalty amount of the currency that the molding material converter 4 will need to transmit to the proprietor 2 in accordance with the terms of the license. The penalty-bill transmitting operation 460, including transmitting, over the communication network 102, the penalty-bill request signal to the molding material converter financial entity 12. The penalty-bill request signal is indicative of the penalty amount of the currency due and the terms of payment.

The suspend sub-routine 405 may further include the penalty-payment receiving operation 462, including receiving, over the communication network 102, the penalty-payment indication from the proprietor financial entity 6. The penalty-payment indication is indicative that the penalty amount of the currency from the molding material converter financial entity 12 has been received in accordance with the terms of payment. The renew generating operation 466, including generating the renew command signal in accordance with the penalty-payment indication for causing the indexing of the master register 122 for storing the count and the period of time subsequently receivable from the supervisory entity 150. The unlock generating operation 468, including generating the unlock command signal in accordance with the penalty-payment indication. The unlock command signal for causing the supervisory entity 150 to execute the operation that is the unlocking operation of the molding structure 200 in accordance with the license, thereby causing the molding structure 200 to be operable.

With reference to FIG. 7, the method 400 may further include a retire sub-routine 407. The retire sub-routine 407 is the same as the period sub-routine 403 up to, and including, the store generating operation 426. Thereafter, the retire sub-routine 407 includes the summary generating operation 470, including generating the summary command signal in response to the store command signal, the summary command signal for causing the calculating of the total cycle count based on the sum of the count indexed in the master register 122 since the master register 122 was initialized. The total service time based on the further sum of the period of time entries indexed in the master register 122 since the master register 122 was initialized. The lock generating operation 472, including generating the lock command signal in accordance with at least one of: the total cycle count reaching the maximum service count parameter associated with the license; and the total service time reaching the maximum service time parameter associated with the license. The lock command signal for causing the supervisory entity 150 to execute the operation that is the locking operation of the molding structure 200 in accordance with the license, thereby causing the molding structure 200 to be inoperable thereby canceling the license.

The retire sub-routine 407 may further include the summary generating operation 470, including generating the summary command signal in response to the store command signal, the summary command signal for causing the calculating of the total cycle count based on the sum of the count indexed in the master register 122 since the master register 122 was initialized. The total service time based on the further sum of the period of time entries indexed in the master register 122 since the master register 122 was initialized. The lock generating operation 472, including generating the lock command signal in accordance with at least one of: the total cycle count reaching the maximum service count parameter associated with the license; and the total service time reaching the maximum service time parameter associated with the license. The lock command signal for causing the supervisory entity 150 to execute the operation that is the locking operation of the molding structure 200 in accordance with the license, thereby causing the molding structure 200 to be inoperable thereby canceling the license.

The retire sub-routine 407 may further include the sale generating operation 476, including generating the sale command signal, the sale command signal for causing the calculating of the residual amount of the currency that the molding material converter 4 will need to transmit to the proprietor 2 in order to purchase the molding structure 200 in accordance with the residual-value parameter of the license. The residual-bill transmitting operation 474, including transmitting, over the communication network 102, the residual-bill request signal to the molding material converter financial entity 12. The residual-bill request signal is indicative of the residual amount of the currency.

With reference to FIG. 8, the method 400 may further include a decommission sub-routine 409. The decommission sub-routine 409 includes the decommission receiving operation 438, including receiving, over the communication network 102, the decommission indication from the molding material converter 4. The decommission indication is indicative of the molding structure 200 being decommissioned by the molding material converter 4. The recovery generating operation 444, including generating the recovery command signal in response to the decommission indication for causing the service entity 10 associated with the proprietor 2 to recover the molding structure 200 from the molding material converter 4.

The decommission sub-routine 409 may further include the recovery receiving operation 442, including receiving, over the communication network 102, the recovery indication from the service entity 10, the recovery indication is indicative of the recovery of the molding structure 200 by the proprietor 2. The inspect generating operation 450, including generating the inspect command signal in response to the recovery indication, the inspect command signal for causing the manufacturing entity 8 to inspect the molding structure 200 for reusability. The inspect transmitting operation 446, including transmitting, over the communication network 102, the inspect command signal to the manufacturing entity 8. The inspect receiving operation 448, including receiving, over the communication network 102, the inspection indication from the manufacturing entity 8. The inspection indication is indicative of the refurbishment requirement of the molding structure 200.

The decommission sub-routine 409 may further include the refurbishment generating operation 456, including generating the refurbishment command signal in response to the inspection indication. The refurbishment command signal for causing the manufacturing entity 8 to refurbish the molding structure 200, at least in part, in accordance with the refurbishment requirement. The refurbishment receiving operation 452, including receiving, over the communication network 102, the refurbishment indication from the manufacturing entity 8. The refurbishment indication is indicative of the molding structure 200, at least in part, having been refurbished in accordance with the refurbishment requirement.

With reference to FIG. 9, the method 400 may further include a maintenance sub-routine 411. The maintenance sub-routine 411 includes the maintenance receiving operation 480, including receiving, over the communication network 102, the maintenance indication from the supervisory entity 150. The maintenance indication is indicative of the maintenance requirement of the molding structure 200. The maintenance generating operation 486, including generating the maintenance command signal in response to the maintenance indication. The maintenance command signal for causing the service entity 10 associated with the proprietor 2 to service the molding structure 200 in accordance with the maintenance requirement. The maintenance transmitting operation 484, including transmitting, over the communication network 102, the maintenance command signal to the service entity 10.

The maintenance sub-routine 411 may further include the lock generating operation 490, including generating the lock command signal in accordance with the maintenance indication. The lock command signal for causing the supervisory entity 150 to execute the operation that is the locking operation of the molding structure 200 in accordance with the license, thereby causing the molding structure 200 to be inoperable and thereby preventing damage to the molding structure 200. The serviced receiving operation 488, including receiving, over the communication network 102, the serviced indication from the service entity 10. The serviced indication is indicative of the maintenance requirement of the molding structure 200 having been addressed. The unlock generating operation 492, including generating the unlock command signal in accordance with the serviced indication. The unlock command signal for causing the supervisory entity 150 to execute the operation that is the unlocking operation of the molding structure 200 in accordance with the license, thereby causing the molding structure 200 to be operable.

The maintenance sub-routine 411 may further includes the maintenance-bill generating operation 498, including generating the maintenance-bill command signal in response to the serviced indication. The maintenance-bill command signal for causing the calculating of the maintenance amount of the currency that the molding material converter 4 will need to transmit to the proprietor 2 for addressing the maintenance requirement of the molding structure 200 in accordance with the maintenance parameter of the license. The maintenance-bill transmitting operation 494, including transmitting, over the communication network 102, the maintenance-bill request signal to the molding material converter financial entity 12. The maintenance-bill request signal is indicative of the maintenance amount of the currency due and terms of payment.

The maintenance sub-routine 411 may further include the maintenance-payment receiving operation 496, including receiving, over the communication network 102. The maintenance-payment indication of the parameter of the license from the proprietor financial entity 6. The maintenance-payment indication is indicative that the maintenance amount of the currency from the molding material converter financial entity 12 has not been received in accordance with the terms of payment. The lock generating operation 499, including generating the lock command signal in accordance with the maintenance-payment indication. The lock command signal for causing the supervisory entity 150 to execute the operation that is the locking operation of the molding structure 200 in accordance with the penalty parameter of the license, thereby causing the molding structure 200 to be inoperable.

### Method of Operating the Supervisory Entity

Shown with reference to FIG. 10, the method 500 executable in the supervisory entity 150 according the foregoing non-limiting embodiment includes the sending operation 502, including sending, over the communication network 102, the indication of the parameter of the license associated with the molding structure 200 to the asset management entity 110. The accepting operation 504, including accepting, over the communication network 102, the command signal from the asset management entity 110, the command signal being generatable in the asset management entity 110 in accordance with the indication. The producing operation 506, including producing the operation signal in accordance with the command signal for causing the molding structure 200 to execute the operation in accordance with the license.

The operation in accordance with the license may include one of the locking operation or the unlocking operation of the molding structure 200.

The sending of the indication of the parameter of the license may include sending the account indication of the account parameter of the license. In the scenario that the account indication being indicative of the license being in good standing, the accepting the command signal from the asset management entity 110 includes accepting the unlock command signal in accordance with the account indication. The producing the operation signal in accordance with the command signal includes producing the unlocking operation signal in accordance with the unlock command signal, the unlocking operation signal for causing the operation that is the unlocking operation of the molding structure 200 in accordance with the license, thereby causing the molding structure 200 to be operable.

Likewise, the account indication may be indicative of the license being in arrears. In such a scenario, the accepting the command signal from the asset management entity 110 includes accepting the lock command signal in accordance with the account indication. The producing the operation signal in accordance with the command signal includes producing the locking operation signal in accordance with the lock command signal. The locking operation signal for causing the operation that is the locking operation of the molding structure 200 in accordance with the license, thereby causing the molding structure 200 to be inoperable.

Alternatively, the sending of the indication of the parameter of the license includes sending the acceptance indication of the acceptance parameter of the license. The acceptance indication is indicative of the molding structure 200, and the license associated therewith, having been accepted by the molding material converter 4. The accepting the command signal from the asset management entity 110 includes accepting the unlock command signal in accordance with the acceptance indication. The producing the operation signal in accordance with the command signal includes producing the unlocking operation signal in accordance with the unlock command signal. The unlocking operation signal for causing the operation that is the unlocking operation of the molding structure 200 in accordance with the license, thereby causing the molding structure 200 to be operable.

With reference to FIG. 11, the method 500 may further include a period-report sub-routine 501. The period-report sub-routine 501 includes the initialize accepting operation 508, including accepting, over the communication network 102, the register-initialize command signal from the asset management entity 110. The initialize producing operation 510, including producing the client register-initialize operation signal for causing the initializing of the client register 156 of the supervisory entity 150, the client register 156 for storing the count of the number of cycles that the molding structure 200 has been operated by the molding material converter 4 over the period of time.

The period-report sub-routine 501 may further include the period-report producing operation 512, including producing the period-report indication of the report parameter of the license. The period-report indication is indicative of the count from the client register 156 over the period of time. The period-report sending operation 514, including sending, over the communication network 102, the period-report indication to the asset management entity 110 for causing the store command signal to be generated in the asset management entity 110 in response to the period-report indication. The store command signal for causing storing of the count and the period of time in the master register 122 of the license management module 120.

The period-report indication may be generated in response to at least one of the count and the period of time reaching predefined values of the reporting count threshold and the reporting time threshold, respectively.

With reference to FIG. 12, the method 500 may further include a decommission-report sub-routine 503. The decommission-report sub-routine 503 includes the decommission producing operation 516, including producing the decommission indication, the decommission indication is indicative of the molding structure 200 being decommissioned by the molding material converter 4. The decommission sending operation 518, including sending, over the communication network 102, the decommission indication to the asset management entity 110 for causing the recovery command signal to be generated in the asset management entity 110 in response to the decommission indication for causing the service entity 10 associated with the proprietor 2 to recover the molding structure 200 from the molding material converter 4.

With reference to FIG. 13, the method 500 may further include a maintenance-report sub-routine 505. The maintenance-report sub-routine 505 includes the monitor accepting operation 520, including accepting the monitor signal from the sensor 158 associated with the molding structure 200, the monitor signal is indicative of the maintenance requirement of the molding structure 200. The maintenance producing operation 522, including producing the maintenance indication in response to the monitor signal, the maintenance indication is indicative of the maintenance requirement of the molding structure 200. The maintenance sending operation 524, including sending, over the communication network 102, the maintenance indication to the asset management entity 110 for causing the maintenance command signal to be generated in the asset management entity 110 in response to the maintenance indication. The maintenance command signal for causing the service entity 10 associated with the proprietor 2 to service the molding structure 200 in accordance with the maintenance requirement.

The description of the exemplary embodiments provides examples of the present invention, and these examples do not limit the scope of the present invention. It is understood that the scope of the present invention is limited by the claims. The concepts described above may be adapted for specific conditions and/or functions, and may be further extended to a variety of other applications that are within the scope of the present invention. Having thus described the exemplary embodiments, it will be apparent that modifications and enhancements are possible without departing from the concepts as described. Therefore, what is to be protected by way of letters patent are limited only by the scope of the following claims:

What is claimed is:

1. A method executable in an asset management entity that includes a license management module, the asset management entity being associated with a proprietor of a molding structure, the molding structure for use by a molding material converter, the method comprising:
a receiving operation, including receiving, over a communication network, an indication of a parameter of a license associated with the molding structure from a supervisory entity associated with the molding structure;
a generating operation, including generating a command signal in accordance with the indication, the command signal for causing the supervisory entity to execute an operation in accordance with the license;
a transmitting operation, including transmitting, over the communication network, the command signal to the supervisory entity.

2. The method of claim 1, wherein:
the operation in accordance with the license is one of a locking operation or an unlocking operation of the molding structure.

3. The method of claim 1, wherein:
the receiving of the indication of the parameter of the license comprises receiving an account indication of an account parameter of the license, the account indication being indicative of the license being in good standing;
the generating the command signal in accordance with the indication comprises generating an unlock command signal in accordance with the account indication, the unlock command signal for causing the supervisory entity to execute the operation that is an unlocking operation of the molding structure in accordance with the license, thereby causing the molding structure to be operable.

4. The method of claim 3, wherein:
the account indication being indicative of the license being in good standing in association with the molding material converter having paid the proprietor for a number of cycles that the molding structure was operated by the molding material converter over a period of time.

5. The method of claim 1, wherein:
the receiving of the indication of the parameter of the license comprises receiving an account indication of an account parameter of the license, the account indication being indicative of the license being in arrears;
the generating the command signal in accordance with the indication comprises generating a lock command signal in accordance with the account indication, the lock command signal for causing the supervisory entity to execute the operation that is a locking operation of the molding structure in accordance with the license, thereby causing the molding structure to be inoperable.

6. The method of claim 5, wherein:
the account indication being indicative of the license being in arrears in association with the molding material converter having not paid the proprietor for a total number of cycles that the molding structure was operated by the molding material converter over a period of time.

7. The method of claim 1, wherein:
the molding structure is at least a portion of one of: an injection molding machine, a hot runner, a mold, a post-mold device, an auxiliary molding device, a controller, and a computer-readable product including controller executable instructions for performing a molding operation.

8. The method of claim 1, wherein the asset management entity further includes a configurating module, and wherein, prior to the receiving operation 402, the method further comprises:
a demand receiving operation, including receiving, over the communication network, a demand indication from the molding material converter, the demand indication is indicative of a demand for the molding structure in accordance with a molding structure specification;
a build generating operation, including generating a build command signal in response to the demand indication, the build command signal for causing a manufacturing entity associated with the proprietor to configure the molding structure in accordance with the molding structure specification;
a build transmitting operation, including transmitting, over the communication network, the build command signal to the manufacturing entity;
a completion receiving operation, including receiving over the communication network, a completion indication from the manufacturing entity that the molding structure is ready for deploying to the molding material converter;
a deploy generating operation, including generating a deploy command signal in response to the completion indication for causing a service entity associated with the proprietor to deploy the molding structure to the molding material converter;
a deploy transmitting operation, including transmitting, over the communication network, the deploy command signal to the service entity.

9. The method of claim 8, wherein:
the receiving of the indication of the parameter of the license comprises receiving an acceptance indication of an acceptance parameter of the license, the acceptance indication is indicative of the molding structure, and the license associated therewith, having been accepted by the molding material converter;
the generating the command signal in accordance with the indication comprises generating an unlock command signal in accordance with the acceptance indication, the unlock command signal for causing the supervisory entity to execute the operation that is an unlocking operation of the molding structure in accordance with the license, thereby causing the molding structure to be operable.

10. The method of claim 9, further comprising:
an initialize generating operation in accordance with the acceptance indication, including generating a register-initialize command signal for causing an initializing of:
a client register of the supervisory entity, the client register for storing a count of a number of cycles that the molding structure has been operated by the molding material converter over a period of time;
a master register of the license management module, the master register for storing the count and the period of time receivable from the supervisory entity;
an initialize transmitting operation, including transmitting, over the communication network, the register-initialize command signal to the supervisory entity.

11. The method of claim 10, further comprising:
a period-report receiving operation, including receiving, over the communication network, a period-report indication of a report parameter of the license from the supervisory entity, the period-report indication is indicative of the count from the client register over the period of time;
a store generating operation, including generating a store command signal in response to the period-report indication, the store command signal for causing storing of the count and the period of time in the master register.

12. The method of claim 11, wherein:
the period-report indication is generatable in the supervisory entity in response to at least one of the count and the period of time reaching predefined values of a reporting count threshold and a reporting time threshold, respectively.

13. The method of claim 11, wherein the asset management entity further includes a proprietor billing module, the method further comprising:
a period-bill generating operation, including generating a period-bill command signal in response to the store command signal, the period-bill command signal for causing a calculating of a period amount of a currency that the molding material converter will need to transmit to the proprietor, the calculating based on at least one of the count and the period of time stored in the master register and a compensation parameter of the license;
a period-bill transmitting operation, including transmitting, over the communication network, a period-bill request signal to a molding material converter financial entity, the period-bill request signal is indicative of the period amount of the currency due and terms of payment.

14. The method of claim 13, wherein:
the compensation parameter of the license is a specified amount of the currency for each cycle of the molding structure taken by the molding material converter.

15. The method of claim 13, further comprising:
a cycle-credit receiving operation, including receiving, over the communication network, a cycle-credit indication of the report parameter of the license from the supervisory entity, the cycle-credit indication is indicative of a cycle-credit count for which the molding material converter is not responsible;
a adjusted-bill generating operation, including generating the period-bill command signal includes the calculating further based on subtracting the cycle-credit count from the count.

16. The method of claim 13, wherein:
the compensation parameter of the license is a specified amount of the currency for a unit of time that the molding structure is with the molding material converter.

17. The method of claim 13, further comprising:
a period-payment receiving operation, including receiving, over the communication network, a period-payment indication of the compensation parameter of the license from a proprietor financial entity, the period-payment indication is indicative that the period amount of the currency from the molding material converter financial entity has been received in accordance with the terms of payment;
a renew generating operation, including generating a renew command signal in accordance with the period-payment indication for causing an indexing of the master register for an indexed storing of the count and the period of time subsequently receivable from the supervisory entity.

18. The method of claim 1, further comprising:
a decommission receiving operation, including receiving, over the communication network, a decommission indication from the molding material converter, the decommission indication is indicative of the molding structure being decommissioned by the molding material converter;
a recovery generating operation, including generating a recovery command signal in response to the decommission indication for causing a service entity associated with the proprietor to recover the molding structure from the molding material converter.

19. The method of claim 18, further comprising:
a recovery receiving operation, including receiving, over the communication network, a recovery indication from the service entity, the recovery indication is indicative of a recovery of the molding structure by the proprietor;
an inspect generating operation, including generating an inspect command signal in response to the recovery indication, the inspect command signal for causing a manufacturing entity to inspect the molding structure for reusability;
an inspect transmitting operation, including transmitting, over the communication network, the inspect command signal to the manufacturing entity;
an inspect receiving operation, including receiving, over the communication network, an inspection indication from the manufacturing entity, the inspection indication is indicative of a refurbishment requirement of the molding structure.

20. The method of claim 19, further comprising:
a refurbishment generating operation, including generating a refurbishment command signal in response to the inspection indication, the refurbishment command signal for causing the manufacturing entity to refurbish the molding structure, at least in part, in accordance with the refurbishment requirement;
a refurbishment receiving operation, including receiving, over the communication network, a refurbishment indication from the manufacturing entity, the refurbishment indication is indicative of the molding structure, at least in part, having been refurbished in accordance with the refurbishment requirement.

21. The method of claim 13, further comprising:
a non-payment receiving operation, including receiving, over the communication network, a non-payment indication of the compensation parameter of the license from a proprietor financial entity, the non-payment indication is indicative that the period amount of the currency from the molding material converter financial entity has not been received in accordance with the terms of payment;
a lock generating operation, including generating a lock command signal in accordance with the non-payment indication, the lock command signal for causing the supervisory entity to execute the operation that is a locking operation of the molding structure in accordance with a penalty parameter of the license, thereby causing the molding structure to be inoperable and thereby suspending the license;
a penalty-bill generating operation, including generating a penalty-bill command signal in response to the non-payment indication, the penalty-bill command signal for causing a calculation of a penalty amount of the currency that the molding material converter will need to transmit to the proprietor in accordance with the terms of the license;
a penalty-bill transmitting operation, including transmitting, over the communication network, a penalty-bill request signal to the molding material converter financial entity, the penalty-bill request signal is indicative of the penalty amount of the currency due and the terms of payment.

22. The method of claim 21, further comprising:
a penalty-payment receiving operation, including receiving, over the communication network, a penalty-payment indication from the proprietor financial entity, the penalty-payment indication is indicative that the penalty amount of the currency from the molding material converter financial entity has been received in accordance with the terms of payment;
a renew generating operation, including generating a renew command signal in accordance with the penalty-payment indication for causing an indexing of the master register for storing the count and the period of time subsequently receivable from the supervisory entity;
a unlock generating operation, including generating the unlock command signal in accordance with the penalty-payment indication, the unlock command signal for causing the supervisory entity to execute the operation that is the unlocking operation of the molding structure in accordance with the license, thereby causing the molding structure to be operable.

23. The method of claim 11, further comprising:
a summary generating operation, including generating a summary command signal in response to the store command signal, the summary command signal for causing a calculating of:
a total cycle count based on a sum of the count indexed in the master register since the master register was initialized;
a total service time based on a further sum of the period of time entries indexed in the master register since the master register was initialized;
a lock generating operation, including generating a lock command signal in accordance with at least one of:
the total cycle count reaching a maximum service count parameter associated with the license; and
the total service time reaching a maximum service time parameter associated with the license;
the lock command signal for causing the supervisory entity to execute the operation that is a locking operation of the molding structure in accordance with the license, thereby causing the molding structure to be inoperable thereby canceling the license.

24. The method of claim 23, wherein the asset management entity further includes a proprietor billing module, the method further comprising:
a sale generating operation, including generating a sale command signal, the sale command signal for causing a calculating of a residual amount of a currency that the molding material converter will need to transmit to the proprietor in order to purchase the molding structure in accordance with a residual-value parameter of the license;
a residual-bill transmitting operation, including transmitting, over the communication network, a residual-bill request signal to a molding material converter financial entity, the residual-bill request signal is indicative of the residual amount of the currency.

25. The method of claim 9, wherein the asset management entity further includes a proprietor billing module, the method further comprising:
an install-bill generating operation, including generating an install-bill command signal in response to the acceptance indication, the install-bill command signal for causing a calculating of an installation amount of a currency that the molding material converter will need to transmit to the proprietor for an installation of the molding structure at the molding material converter by the proprietor;
a install-bill transmitting operation, including transmitting, over the communication network, an install-bill request signal to a molding material converter financial entity, the install-bill request signal is indicative of the installation amount of the currency due and terms of payment.

26. The method of claim 1, further comprising:
a maintenance receiving operation, including receiving, over the communication network, a maintenance indication from the supervisory entity, the maintenance indication is indicative of a maintenance requirement of the molding structure;
a maintenance generating operation, including generating a maintenance command signal in response to the maintenance indication, the maintenance command signal for causing a service entity associated with the proprietor to service the molding structure in accordance with the maintenance requirement;
a maintenance transmitting operation, including transmitting, over the communication network, the maintenance command signal to the service entity.

27. The method of claim 26, further comprising:
a lock generating operation, including generating a lock command signal in accordance with the maintenance indication, the lock command signal for causing the supervisory entity to execute the operation that is a locking operation of the molding structure in accordance with the license, thereby causing the molding structure to be inoperable and thereby preventing damage to the molding structure;
a serviced receiving operation, including receiving, over the communication network, a serviced indication from the service entity, the serviced indication is indicative of the maintenance requirement of the molding structure having been addressed;
a unlock generating operation, including generating an unlock command signal in accordance with the serviced indication, the unlock command signal for causing the supervisory entity to execute the operation that is an unlocking operation of the molding structure in accordance with the license, thereby causing the molding structure to be operable.

28. The method of claim 27, wherein the asset management entity further includes a proprietor billing module, the method further comprising:
a maintenance-bill generating operation, including generating a maintenance-bill command signal in response to the serviced indication, the maintenance-bill command signal for causing a calculating of a maintenance amount of a currency that the molding material converter will need to transmit to the proprietor for addressing the maintenance requirement of the molding structure in accordance with a maintenance parameter of the license;
a maintenance-bill transmitting operation, including transmitting, over the communication network, a maintenance-bill request signal to a molding material converter financial entity, the maintenance-bill request signal is indicative of the maintenance amount of the currency due and terms of payment.

29. The method of claim 28, further comprising:
a maintenance-payment receiving operation, including receiving, over the communication network, a maintenance-payment indication of the parameter of the license from a proprietor financial entity, the maintenance-payment indication is indicative that the maintenance amount of the currency from the molding material converter financial entity has not been received in accordance with the terms of payment;
a further lock generating operation, including generating the lock command signal in accordance with the maintenance-payment indication, the lock command signal for causing the supervisory entity to execute the operation that is the locking operation of the molding structure in accordance with a penalty parameter of the license, thereby causing the molding structure to be inoperable.

30. A method executable in a supervisory entity associated with a molding structure for use by a molding material converter, the method comprising:
a sending operation, including sending, over a communication network, an indication of a parameter of a license associated with the molding structure to an asset management entity that includes a license management module, the asset management entity being associated with a proprietor of the molding structure;
an accepting operation, including accepting, over the communication network, a command signal from the asset management entity, the command signal being generatable in the asset management entity in accordance with the indication;
a producing operation, including producing an operation signal in accordance with the command signal for causing the molding structure to execute an operation in accordance with the license.

31. The method of claim 30, wherein:
the operation in accordance with the license is one of a locking operation or an unlocking operation of the molding structure.

32. The method of claim 30, wherein:
the sending of the indication of the parameter of the license comprises sending an account indication of an account parameter of the license, the account indication being indicative of the license being in good standing;
the accepting the command signal from the asset management entity comprises accepting an unlock command signal in accordance with the account indication, and wherein, the command signal being generatable in the asset management entity in accordance with the indication comprises the unlock command signal being generatable in accordance with the account indication;
the producing the operation signal in accordance with the command signal comprises producing an unlocking operation signal in accordance with the unlock command signal, the unlocking operation signal for causing the operation that is an unlocking operation of the molding structure in accordance with the license, thereby causing the molding structure to be operable.

33. The method of claim 32, wherein:
the account indication being indicative of the license being in good standing in association with the molding material converter having paid the proprietor for a number of cycles that the molding structure was operated by the molding material converter over a period of time.

34. The method of claim 30, wherein:
the sending of the indication of the parameter of the license comprises sending an account indication of an account parameter of the license, the account indication being indicative of the license being in arrears;
the accepting the command signal from the asset management entity comprises accepting a lock command signal in accordance with the account indication, and wherein, the command signal being generatable in the asset management entity in accordance with the indication comprises the lock command signal being generatable in accordance with the account indication;
the producing the operation signal in accordance with the command signal comprises producing a locking operation signal in accordance with the lock command signal, the locking operation signal for causing the operation that is a locking operation of the molding structure in accordance with the license, thereby causing the molding structure to be inoperable.

35. The method of claim 34, wherein:
the account indication being indicative of the license being in arrears in association with the molding material converter having not paid the proprietor for a total number of cycles that the molding structure was operated by the molding material converter over a period of time.

36. The method of claim 30, wherein:
the molding structure is at least a portion of one of: an injection molding machine, a hot runner, a mold, a post-mold device, an auxiliary molding device, a controller, and a computer-readable product including controller executable instructions for performing a molding operation.

37. The method of claim 30, wherein:
the sending of the indication of the parameter of the license comprises sending an acceptance indication of an acceptance parameter of the license, the acceptance indication is indicative of the molding structure, and the license associated therewith, having been accepted by the molding material converter;
the accepting the command signal from the asset management entity comprises accepting an unlock command signal in accordance with the acceptance indication, and wherein, the command signal being generatable in the asset management entity in accordance with the indication comprises the unlock command signal being generatable in accordance with the acceptance indication;
the producing the operation signal in accordance with the command signal comprises producing an unlocking operation signal in accordance with the unlock command signal, the unlocking operation signal for causing the operation that is an unlocking operation of the molding structure in accordance with the license, thereby causing the molding structure to be operable.

38. The method of claim 30, further comprising:
an initialize accepting operation, including accepting, over the communication network, a register-initialize command signal from the asset management entity;
an initialize producing operation, including producing a client register-initialize operation signal for causing an initializing of a client register of the supervisory entity, the client register for storing a count of a number of cycles that the molding structure has been operated by the molding material converter over a period of time.

39. The method of claim 38, further comprising:
a period-report producing operation, including producing a period-report indication of a report parameter of the license, the period-report indication is indicative of the count from the client register over the period of time;
a period-report sending operation, including sending, over the communication network, the period-report indication to the asset management entity for causing a store command signal to be generated in the asset management entity in response to the period-report indication, the store command signal for causing storing of the count and the period of time in a master register of the license management module.

40. The method of claim 39, wherein:
the producing the period-report indication is in response to at least one of the count and the period of time reaching predefined values of a reporting count threshold and a reporting time threshold, respectively.

41. The method of claim 30, further comprising:
a decommission producing operation, including producing a decommission indication, the decommission indication is indicative of the molding structure being decommissioned by the molding material converter;
a decommission sending operation, including sending, over the communication network, the decommission indication to the asset management entity for causing a recovery command signal to be generated in the asset management entity in response to the decommission indication for causing a service entity associated with the proprietor to recover the molding structure from the molding material converter.

42. The method of claim 30, further comprising:
a monitor accepting operation, including accepting a monitor signal from a sensor associated with the molding structure, the monitor signal is indicative of a maintenance requirement of the molding structure;
a maintenance producing operation, including producing a maintenance indication in response to the monitor signal, the maintenance indication is indicative of the maintenance requirement of the molding structure;
a maintenance sending operation, including sending, over the communication network, the maintenance indication to the asset management entity for causing a maintenance command signal to be generated in the asset management entity in response to the maintenance indication, the maintenance command signal for causing a service entity associated with the proprietor to service the molding structure in accordance with the maintenance requirement.

43. An asset management entity being associated with a proprietor of a molding structure, the molding structure for use by a molding material converter, the asset management entity comprising:
a computing apparatus;
a computing apparatus interface associated with the computing apparatus, the computing apparatus interface is configured to operatively couple, in use, the computing apparatus to a communication network for communications with a supervisory entity associated with the molding structure;
the computing apparatus is configured to execute, in use, a receiving operation, over the communication network, to receive an indication of a parameter of a license associated with the molding structure from the supervisory entity;
a license management module associated with the computing apparatus, the license management module is configured to execute, in use, a generating operation, to generate a command signal in accordance with the indication, the command signal for causing the supervisory entity to execute an operation in accordance with the license;
the computing apparatus is configured to execute, in use, a transmitting operation, to transmit, over the communication network, the command signal to the supervisory entity.

44. The asset management entity of claim 43, wherein:
the command signal in accordance with the indication for causing the supervisory entity to execute the operation in accordance with the license that is a locking operation or an unlocking operation of the molding structure.

45. The asset management entity of claim 43, wherein:
the indication of the parameter of the license comprises an account indication of an account parameter of the license, the account indication being indicative of the license being in good standing;
the command signal in accordance with the indication comprises an unlock command signal in accordance with the account indication, the unlock command signal for causing the supervisory entity to execute the operation that is an unlocking operation of the molding structure in accordance with the license, thereby causing the molding structure to be operable.

46. The asset management entity of claim 45, wherein:
the license management module generates, in use, the unlock command signal when the account indication being indicative of the license being in good standing in association with the molding material converter having paid the proprietor for a total number of cycles that the molding structure was operated by the molding material converter over a period of time.

47. The asset management entity of claim 43, wherein:
the indication of the parameter of the license comprises an account indication of an account parameter of the license, the account indication being indicative of the license being in arrears;
the command signal in accordance with the indication comprises a lock command signal in accordance with the account indication, the lock command signal for causing the supervisory entity to execute the operation that is a locking operation of the molding structure in accordance with the license, thereby causing the molding structure to be inoperable.

48. The asset management entity of claim 47, wherein:
the license management module generates, in use, the lock command signal when the account indication being indicative of the license being in arrears in association with the molding material converter having not paid the proprietor for a total number of cycles that the molding structure was operated by the molding material converter over a period of time.

49. The asset management entity of claim 43, wherein:
the molding structure is at least a portion of one of: an injection molding machine, a hot runner, a mold, a post-mold device, an auxiliary molding device, a controller, and a computer-readable product including controller executable instructions for performing a molding operation.

50. The asset management entity of claim 49, wherein:
the molding structure is configured in accordance with a flexible design.

51. The asset management entity of claim 43, further comprising:
a configurating module; and wherein
the computing apparatus is configured to execute, in use, a demand receiving operation to receive, over the communication network, a demand indication from the molding material converter, the demand indication is indicative of a demand for the molding structure in accordance with a molding structure specification;
the configurating module is configured to execute, in use, a build generating operation to generate a build command signal in response to the demand indication, the build command signal for causing a manufacturing entity associated with the proprietor to configure the molding structure in accordance with the molding structure specification;
the computing apparatus is configured to execute, in use, a build transmitting operation to transmit over the communication network, the build command signal to the manufacturing entity;
the computing apparatus is configured to execute, in use, a completion receiving operation to receive over the communication network, a completion indication from the manufacturing entity that the molding structure is ready for deploying to the molding material converter;
the computing apparatus is configured to execute, in use, a deploy generating operation to generate a deploy command signal in response to the completion indication for causing a service entity associated with the proprietor to deploy the molding structure to the molding material converter;
the computing apparatus is configured to execute, in use, a deploy transmitting operation to transmit, in use, over the communication network, the deploy command signal to the service entity.

52. The asset management entity of claim 51, wherein:
the indication of the parameter of the license comprises an acceptance indication of an acceptance parameter of the license, the acceptance indication is indicative of the molding structure, and the license associated therewith, having been accepted by the molding material converter;
the command signal in accordance with the indication comprises an unlock command signal in accordance with the acceptance indication, the unlock command signal for causing the supervisory entity to execute the operation that is an unlocking operation of the molding structure in accordance with the license, thereby causing the molding structure to be operable.

53. The asset management entity of claim 52, further comprising:
a master register associated with the license management module, the master register is configured to store a count and a period of time receivable from a client register associated with the supervisory entity; and wherein
the license management module is configured to execute, in use, an initialize generating operation in accordance with the acceptance indication to generate a register-initialize command signal for causing an initializing of:
the client register of the supervisory entity, the client register for storing the count of a number of cycles that the molding structure has been operated by the molding material converter over the period of time;
the master register;
the computing apparatus is configured to execute, in use, an initialize transmitting operation to transmit, over the communication network, the register-initialize command signal to the supervisory entity.

54. The asset management entity of claim 53, wherein:
the computing apparatus is configured to execute, in use, a period-report receiving operation to receive, over the communication network, a period-report indication of a report parameter of the license from the supervisory entity, the period-report indication is indicative of the count from the client register over the period of time;
the license management module is configured to execute, in use, a store generating operation to generate a store command signal in response to the period-report indication, the store command signal for causing storing of the count and the period of time in the master register.

55. The asset management entity of claim 54, further comprising:
a proprietor billing module; and wherein
the proprietor billing module is configured to execute, in use, a period-bill generating operation to generate a period-bill command signal in response to the store command signal, the period-bill command signal for causing a calculation of a period amount of a currency that the molding material converter will need to transmit to the proprietor, the calculating based on at least one of the count and the period of time stored in the master register and a compensation parameter of the license;
the computing apparatus is configured to execute, in use, a period-bill transmitting operation to transmit, over the communication network, a period-bill request signal to a molding material converter financial entity, the period-bill request signal is indicative of the period amount of the currency due and terms of payment.

56. The asset management entity of claim 55, wherein:
the computing apparatus is configured to execute, in use, a cycle-credit receiving operation to receive, over the communication network, a cycle-credit indication of the report parameter of the license from the supervisory entity, the cycle-credit indication is indicative of a cycle-credit count for which the molding material converter is not responsible;
the proprietor billing module is configured to execute, in use, adjusted-bill generating operation to generate the period-bill command signal wherein the calculation further based on subtracting the cycle-credit count from the count.

57. The asset management entity of claim 55, wherein:
the compensation parameter of the license is a specified amount of the currency for a unit of time that the molding structure is with the molding material converter.

58. The asset management entity of claim 55, wherein:
the computing apparatus is configured to execute, in use, a period-payment receiving operation to receive, over the communication network, a period-payment indication of the compensation parameter of the license from a proprietor financial entity, the period-payment indication is indicative that the period amount of the currency from the molding material converter financial entity has been received in accordance with the terms of payment;
the license management module is configured to execute, in use, an renew generating operation to generate a renew command signal in accordance with the period-payment indication for causing an indexing of the master register for an indexed storing of the count and the period of time subsequently receivable from the supervisory entity.

59. The asset management entity of claim 58, wherein
the computing apparatus is configured to execute, in use, a decommission receiving operation to receive, over the communication network, a decommission indication from the molding material converter, the decommission indication is indicative of the molding structure being decommissioned by the molding material converter;
the computing apparatus is configured to execute, in use, a recovery generating operation to generate a recovery command signal in response to the decommission indication for causing the service entity associated with the proprietor to recover the molding structure from the molding material converter.

60. The asset management entity of claim 59, wherein:
the computing apparatus is configured to execute, in use, a recovery receiving operation to receive, over the communication network, a recovery indication from the service entity, the recovery indication is indicative of a recovery of the molding structure by the proprietor;
the computing apparatus is configured to execute, in use, inspect generating operation to generate an inspect command signal in response to the recovery indication, the inspect command signal for causing the manufacturing entity to inspect the molding structure for reusability;
the computing apparatus is configured to execute, in use, an inspect transmitting operation to transmit, over the communication network, the inspect command signal to the manufacturing entity;
the computing apparatus is configured to execute, in use, a inspection receiving operation to receive, over the communication network, an inspection indication from the manufacturing entity, the inspection indication is indicative of a refurbishment requirement of the molding structure.

61. The asset management entity of claim 60, wherein:
the computing apparatus is configured to execute, in use, a refurbishment generating operation to generate a refurbishment command signal in response to the inspection indication, the refurbishment command signal for causing the manufacturing entity to refurbish the molding structure, at least in part, in accordance with the refurbishment requirement;
the computing apparatus is configured to execute, in use, a refurbishment receiving operation to receive, over the communication network, a refurbishment indication from the manufacturing entity, the refurbishment indication is indicative of the molding structure, at least in part, having been refurbished in accordance with the refurbishment requirement.

62. The asset management entity of claim 55, wherein:
the computing apparatus is configured to execute, in use, a non-payment receiving indication to receive, over the communication network, a non-payment indication of the compensation parameter of the license from a proprietor financial entity, the non-payment indication is indicative that the period amount of the currency from the molding material converter financial entity has not been received in accordance with the terms of payment;
the license management module is configured to execute, in use, a lock generating operation to generate a lock command signal in accordance with the non-payment indication, the lock command signal for causing the supervisory entity to execute the operation that is a locking operation of the molding structure in accordance with a penalty parameter of the license, thereby causing the molding structure to be inoperable and thereby suspending the license;
the proprietor billing module is configured to execute, in use, penalty-bill generating operation to generate a penalty-bill command signal in response to the non-payment indication, the penalty-bill command signal for causing the calculation of a penalty amount of the currency that the molding material converter will need to transmit to the proprietor in accordance with the terms of the license;
the computing apparatus is configured to execute, in use, a penalty-bill transmitting operation to transmit, over the communication network, a penalty-bill request signal to the molding material converter financial entity, the penalty-bill request signal is indicative of the penalty amount of the currency due and the terms of payment.

63. The asset management entity of claim 62, wherein:
the proprietor billing module is configured to execute, in use, a penalty-payment receiving operation to receive, over the communication network, a penalty-payment indication from the proprietor financial entity, the penalty-payment indication is indicative that the penalty amount of the currency from the molding material converter financial entity has been received in accordance with the terms of payment;
the license management module is configured to execute, in use, a renew generating operation to generate a renew command signal in accordance with the penalty-payment indication for causing an indexing of the master register for storing the count and the period of time subsequently receivable from the supervisory entity;
the license management module is configured to execute, in use, a unlock generating operation to generate the unlock command signal in accordance with the penalty-payment indication, the unlock command signal for causing the supervisory entity to execute the operation that is the unlocking operation of the molding structure in accordance with the license, thereby causing the molding structure to be operable.

64. The asset management entity of claim 54, wherein:
the license management module is configured to execute, in use, a summary generating operation to generate a summary command signal in response to the store command signal, the summary command signal for causing a calculating of:
a total cycle count based on a sum of the count indexed in the master register since the master register was initialized;
a total service time based on a further sum of the period of time entries indexed in the master register since the master register was initialized;
the license management module is configured to execute, in use, a lock generating operation to generate a lock command signal in accordance with at least one of:
the total cycle count reaching a maximum service count parameter associated with the license; and
the total service time reaching a maximum service time parameter associated with the license;
the lock command signal for causing the supervisory entity to execute the operation that is a locking operation of the molding structure in accordance with the license, thereby causing the molding structure to be inoperable thereby canceling the license.

65. The asset management entity of claim 64, further comprising:
a proprietor billing module; and wherein
the proprietor billing module is configured to execute, in use, a sale generating operation to generate a sale command signal, the sale command signal for causing a calculating of a residual amount of a currency that the molding material converter will need to transmit to the proprietor in order to purchase the molding structure in accordance with a residual-value parameter of the license;
the computing apparatus is configured execute, in use, a residual-bill transmitting operation to transmit, over the communication network, a residual-bill request signal to a molding material converter financial entity, the residual-bill request signal is indicative of the residual amount of the currency.

66. The asset management entity of claim 44, wherein:
the computing apparatus is configured to execute, in use, a maintenance receiving operation to receive, over the communication network, a maintenance indication from the supervisory entity, the maintenance indication is indicative of a maintenance requirement of the molding structure;
the computing apparatus is configured to execute, in use, maintenance generating operation to generate a maintenance command signal in response to the maintenance indication, the maintenance command signal for causing a service entity associated with the proprietor to service the molding structure in accordance with the maintenance requirement;
the computing apparatus is configured to execute, in use, a maintenance transmitting operation to transmit, over the communication network, the maintenance command signal to the service entity.

67. The asset management entity of claim 66, wherein:
the license management module is configured to execute, in use, a lock generating operation to generate a lock command signal in accordance with the maintenance indication, the lock command signal for causing the supervisory entity to execute the operation that is the locking operation of the molding structure in accordance with the license, thereby causing the molding structure to be inoperable and thereby preventing damage to the molding structure;
the computing apparatus is configured to execute, in use, a serviced receiving operation to receive, over the communication network, a serviced indication from the service entity, the serviced indication is indicative of the maintenance requirement of the molding structure having been addressed;
the license management module is configured to execute, in use, a unlock generating operation to generate an unlock command signal in accordance with the serviced indication, the unlock command signal for causing the supervisory entity to execute the operation that is the unlocking operation of the molding structure in accordance with the license, thereby causing the molding structure to be operable.

68. The asset management entity of claim 67, further comprising:
a proprietor billing module; and wherein
the proprietor billing module is configured to execute, in use, a maintenance-bill generating operation to generate a maintenance-bill command signal in response to the serviced indication, the maintenance-bill command signal for causing a calculating of a maintenance amount of a currency that the molding material converter will need to transmit to the proprietor for addressing the maintenance requirement of the molding structure in accordance with a maintenance parameter of the license;
the computing apparatus is configured to execute, in use, a maintenance-bill transmitting operation to transmit, over the communication network, a maintenance-bill request signal to a molding material converter financial entity, the maintenance-bill request signal is indicative of the maintenance amount of the currency due and terms of payment.

69. The asset management entity of claim 68, wherein:
the computing apparatus is configured to execute, in use, a maintenance-payment receiving operation to receive, over the communication network, a maintenance-payment indication of the parameter of the license from a proprietor financial entity, the maintenance-payment indication is indicative that the maintenance amount of the currency from the molding material converter financial entity has not been received in accordance with the terms of payment;
the license management module is configured to execute, in use, a further lock generating operation to generate the lock command signal in accordance with the maintenance-payment indication, the lock command signal for causing the supervisory entity to execute the operation that is the locking operation of the molding structure in accordance with a penalty parameter of the license, thereby causing the molding structure to be inoperable.

70. A supervisory entity being associated with a molding structure, the molding structure for use by a molding material converter, the supervisory entity, comprising:
a computing device;
a computing device interface associated with the computing device, the computing device interface is configured to operatively couple, in use, the computing device to a communication network for communications with an asset management entity associated with a proprietor of the molding structure;
the computing device is configured to execute, in use, a sending operation to send, over the communication network, an indication of a parameter of a license associated with the molding structure to the asset management entity that includes a license management module;
the computing device is configured to execute, in use, a accepting operation to accept, over the communication network, a command signal from the asset management entity, the command signal being generatable in the asset management entity in accordance with the indication;
the computing device is configured to execute, in use, a producing operation to produce an operation signal in accordance with the command signal for causing the molding structure to execute an operation in accordance with the license.

71. The supervisory entity of claim 70, wherein:
the operation signal in accordance with the command signal for causing a locking structure associated with the molding structure to execute the operation in accordance with the license that is one of a locking operation or an unlocking operation of the molding structure.

72. The supervisory entity of claim 70, wherein:
the indication of the parameter of the license comprises an account indication of an account parameter of the license, the account indication being indicative of the license being in good standing;
the command signal from the asset management entity comprises an unlock command signal in accordance with the account indication, and wherein, the command signal being generatable in the asset management entity in accordance with the indication comprises the unlock command signal being generatable in accordance with the account indication;
the operation signal in accordance with the command signal comprises an unlocking operation signal in accordance with the unlock command signal, the unlocking operation signal for causing a locking structure associated with the molding structure to execute the operation that is an unlocking operation of the molding structure in accordance with the license, thereby causing the molding structure to be operable.

73. The supervisory entity of claim 70, wherein:
the indication of the parameter of the license comprises an account indication of an account parameter of the license, the account indication being indicative of the license being in arrears;
the command signal from the asset management entity comprises a lock command signal in accordance with the account indication, and wherein, the command signal being generatable in the asset management entity in accordance with the indication comprises the lock command signal being generatable in accordance with the account indication;
the operation signal in accordance with the command signal comprises a locking operation signal in accordance with the lock command signal, the locking operation signal for causing a locking structure associated with the molding structure to execute the operation that is a locking operation of the molding structure in accordance with the license, thereby causing the molding structure to be inoperable.

74. The supervisory entity of claim 70, wherein:
the molding structure is at least a portion of one of: an injection molding machine, a hot runner, a mold, a post-mold device, an auxiliary molding device, a controller, and a computer-readable product including controller executable instructions for performing a molding operation.

75. The supervisory entity of claim 74, wherein:
the molding structure is configured in accordance with a flexible design.

76. The supervisory entity of claim 70, wherein:
the indication of the parameter of the license comprises an acceptance indication of an acceptance parameter of the license, the acceptance indication is indicative of the molding structure, and the license associated therewith, having been accepted by the molding material converter;
the command signal from the asset management entity comprises an unlock command signal in accordance with the acceptance indication, and wherein, the command signal being generatable in the asset management entity in accordance with the indication comprises the unlock command signal being generatable in accordance with the acceptance indication;
the operation signal in accordance with the command signal comprises an unlocking operation signal in accordance with the unlock command signal, the unlocking operation signal for causing a locking structure associated with the molding structure to execute the operation that is an unlocking operation of the molding structure in accordance with the license, thereby causing the molding structure to be operable.

77. The supervisory entity of claim 70, further comprising:
a client register for storing a count of a number of cycles that the molding structure has been operated by the molding material converter over a period of time; and wherein
the computing device is configured to execute, in use, an initialize accepting operation to accept, over the communication network, a register-initialize command signal from the asset management entity;
the computing device is configured to execute, in use, an initialize producing operation to produce a client register-initialize operation signal for causing an initializing of the client register of the supervisory entity.

78. The supervisory entity of claim 77, wherein:
the computing device is configured to execute, in use, a period-report producing operation to produce a period-report indication of a report parameter of the license, the period-report indication is indicative of the count from the client register over the period of time;
the computing device is configured to execute, in use, a period-report sending operation to send, over the communication network, the period-report indication to the asset management entity, a store command signal being generatable in the asset management entity in response to the period-report indication, the store command signal for causing storing of the count and the period of time in a master register of the license management module.

79. The supervisory entity of claim 78, wherein:
the computing device is configured to execute, in use, the period-report producing operation, in response to at least one of the count and the period of time reaching predefined values of a reporting count threshold and a reporting time threshold, respectively.

80. The supervisory entity of claim 70, further comprising:
the computing device is configured to execute, in use, a decommission producing operation to produce a decommission indication, the decommission indication is indicative of the molding structure being decommissioned by the molding material converter;
the computing device is configured to execute, in use, a decommission sending operation to send, over the communication network, the decommission indication to the asset management entity, a recovery command signal being generatable in the asset management entity in response to the decommission indication for causing a service entity associated with the proprietor to recover the molding structure from the molding material converter.

81. The supervisory entity of claim 70, further comprising:
the computing device is configured to execute, in use, a monitor accepting operation to accept, over the communication network, a monitor signal from a sensor associated with the molding structure, the monitor signal is indicative of a maintenance requirement of the molding structure;
the computing device is configured to execute, in use, a maintenance producing operation to produce a maintenance indication in response to the monitor signal, the maintenance indication is indicative of the maintenance requirement of the molding structure;
the computing device is configured to execute, in use, a maintenance sending operation to send, over the communication network, the maintenance indication to the asset management entity, a maintenance command signal being generatable in the asset management entity in response to the maintenance indication, the maintenance command signal for causing a service entity associated with the proprietor to service the molding structure in accordance with the maintenance requirement.
